(19) United States
(12) Patent Application Publication
(10) Pub. No.: US 2025/0338293 A1
(43) Pub. Date: Oct. 30, 2025

(54) CONDITIONAL TRANSMISSIONS USING ADDITIONAL STARTING POSITIONS FOR UNLICENSED SIDELINK COMMUNICATIONS

(71) Applicant: QUALCOMM Incorporated, San Diego, CA (US)

(72) Inventors: Stelios STEFANATOS, San Diego, CA (US); Chih-Hao LIU, San Diego, CA (US); Gabi SARKIS, San Diego, CA (US); Giovanni CHISCI, San Diego, CA (US); Guangyi LIU, Shanghai (CN)

(21) Appl. No.: 18/872,002

(22) PCT Filed: Jun. 13, 2023
(86) PCT No.: PCT/US2023/068347

§ 371 Date: Dec. 5, 2024

(30) Foreign Application Priority Data
Jul. 22, 2022 (GR) 20220100589

(51) Int. Cl. H04W 72/25; H04L 27/26; H04W 72/0446

(52) U.S. Cl. CPC H04W 72/25; H04L 27/26025; H04W 72/0446

(57) ABSTRACT

Various aspects of the present disclosure generally relate to wireless communication. In some aspects, a user equipment (UE) may perform one or more measurements associated with a channel access procedure for accessing a shared or unlicensed sidelink channel. The UE may transmit, based at least in part on the one or more measurements satisfying an energy detection threshold, a sidelink communication at a starting time domain location that is aligned with a boundary of a slot based at least in part on one or more conditions not being satisfied, or that is one of multiple available starting time domain locations of the slot based at least in part on the one or more conditions being satisfied, the multiple available starting time domain locations of the slot including one or more starting time domain locations that are not aligned with any slot boundary. Numerous other aspects are provided.

### CROSS-REFERENCE TO RELATED APPLICATION

This Patent Application claims priority to Greek patent application Ser. No. 20/220,100589, filed on Jul. 22, 2022, entitled “CONDITIONAL TRANSMISSIONS USING ADDITIONAL STARTING POSITIONS FOR UNLICENSED SIDELINK COMMUNICATIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically, to techniques and apparatuses associated with conditional transmissions using additional starting positions for unlicensed sidelink communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some examples, a user equipment (UE) may transmit or receive sidelink communications using slot-based scheduling. Slot-based scheduling may be associated with a slot as a minimum time unit for resource scheduling in the time domain (for example, a minimum amount of time that can be reserved for a sidelink communication is a slot). In some other examples, sidelink communications may be associated with mini-slot-based scheduling, which may also be referred to as multiple starting position (or multiple starting location) based scheduling. A mini-slot may include a lesser quantity of symbols than a slot. For example, a starting location of a mini-slot may occur 1, 2, 4, 7, or another quantity of OFDM symbols after a start of a slot. Using mini-slot-based scheduling for sidelink communications may increase a flexibility for reserving sidelink resources or may reduce a latency associated with the sidelink communications. However, mini-slot-based scheduling may be associated with increased signaling overhead because more granular resource reservations may be made, thereby resulting in an increased quantity of resource reservations being transmitted in the sidelink network or an increased decoding complexity for a receiving UE.

In some examples, the UE may operate using a shared or unlicensed frequency band. In such examples, the UE may perform a channel access procedure prior to transmitting a sidelink communication via the shared or unlicensed frequency band. The channel access procedure may include sensing or measuring a physical channel associated with the shared or unlicensed frequency band and determining whether the physical channel is idle or busy based at least in part on a received energy of the signals sensed or measured on the physical channel (for example, based at least in part on whether a measurement of the signals satisfies a threshold). However, if the UE uses slot-based scheduling, then in a time between when the UE detects that the physical channel is idle and a start of a next slot (for example, the next time at which the UE is permitted to transmit), another device operating using the shared or unlicensed frequency band may sense the physical channel as idle and begin a transmission of a signal that overlaps in time with the start of the next slot. As a result, because the UE delays a transmission of the sidelink signal until the next slot after detecting that the channel is idle, the UE may lose a transmission opportunity.

To address the problems caused by using slot-based scheduling in shared or unlicensed frequency bands, the UE may use mini-slot-based scheduling. For example, in some cases, the UE may use mini-slot-based scheduling to reduce a delay between a time at which a UE detects that the physical channel is an idle channel and a next transmission opportunity by providing additional starting locations for sidelink signals (for example, in addition to a start of a slot, the UE may transmit a sidelink signal at a start of a mini-slot). However, as described above, the use of mini-slot-based scheduling may increase a power consumption and a decoding complexity of the UE.

Additionally, the use of mini-slot-based scheduling may introduce an automatic gain control (AGC) problem for receiving UEs. For example, a receiving UE may perform AGC by measuring one or more symbols (such as a first symbol of a slot) and may configure a gain for one or more receive components (for example, front end components of the receiving UE) based on one or more signal characteristics (for example, a received signal power) associated with the one or more symbols. Accordingly, the receiving UE may apply the gain to process sidelink signals received by the receiving UE (for example, over a slot). For example, the receiving UE may receive a sidelink signal, from a first UE, and may perform an AGC operation based on the measurement of the sidelink signal. However, a second UE may detect that the physical channel is idle (for example, the second UE may not detect or measure the sidelink signal transmitted by the first UE due to a blockage or other obstruction). Therefore, the second UE may transmit another sidelink signal at a start of a mini-slot. If a starting time domain location of the mini-slot is included in a slot (for example, after a starting time domain location of the slot) in which the sidelink signal is transmitted by the first UE, then the receiving UE may receive a higher energy or transmit power than is expected for the slot (for example, expected based on the AGC operation). The additional received energy or power may degrade reception performance of the receiving UE (for example, may cause a saturation of the one or more front end components of the receiving UE).

Therefore, although the use of mini-slot-based scheduling may provide additional starting locations for sidelink signals, thereby increasing a likelihood that UEs are able to transmit the sidelink signals in a shared or unlicensed frequency band, the use of mini-slot-based scheduling may also increase power consumption, increase decoding complexity, or reduce an effectiveness of AGC operations for UEs operating using the mini-slot-based scheduling.

### SUMMARY

Some aspects described herein relate to a user equipment (UE) for wireless communication. The UE may include at least one memory and at least one processor communicatively coupled with the at least one memory. The at least one processor may be configured to cause the UE to perform one or more measurements associated with a channel access procedure for accessing a shared or unlicensed sidelink channel. The at least one processor may be configured to cause the UE to transmit, based at least in part on the one or more measurements satisfying an energy detection threshold, a sidelink communication at a starting time domain location that is aligned with a boundary of a slot based at least in part on one or more conditions not being satisfied, or that is one of multiple available starting time domain locations of the slot based at least in part on the one or more conditions being satisfied, the multiple available starting time domain locations of the slot including one or more starting time domain locations that are not aligned with any slot boundary.

Some aspects described herein relate to a method of wireless communication performed by a UE. The method may include performing one or more measurements associated with a channel access procedure for accessing a shared or unlicensed sidelink channel. The method may include transmitting, based at least in part on the one or more measurements satisfying an energy detection threshold, a sidelink communication at a starting time domain location that is aligned with a boundary of a slot based at least in part on one or more conditions not being satisfied, or that is one of multiple available starting time domain locations of the slot based at least in part on the one or more conditions being satisfied, the multiple available starting time domain locations of the slot including one or more starting time domain locations that are not aligned with any slot boundary.

Some aspects described herein relate to a non-transitory computer-readable medium that stores a set of instructions for wireless communication by a UE. The set of instructions, when executed by one or more processors of the UE, may cause the UE to perform one or more measurements associated with a channel access procedure for accessing a shared or unlicensed sidelink channel. The set of instructions, when executed by one or more processors of the UE, may cause the UE to transmit, based at least in part on the one or more measurements satisfying an energy detection threshold, a sidelink communication at a starting time domain location that is aligned with a boundary of a slot based at least in part on one or more conditions not being satisfied, or that is one of multiple available starting time domain locations of the slot based at least in part on the one or more conditions being satisfied, the multiple available starting time domain locations of the slot including one or more starting time domain locations that are not aligned with any slot boundary.

Some aspects described herein relate to an apparatus for wireless communication. The apparatus may include means for performing one or more measurements associated with a channel access procedure for accessing a shared or unlicensed sidelink channel. The apparatus may include means for transmitting, based at least in part on the one or more measurements satisfying an energy detection threshold, a sidelink communication at a starting time domain location that is aligned with a boundary of a slot based at least in part on one or more conditions not being satisfied, or that is one of multiple available starting time domain locations of the slot based at least in part on the one or more conditions being satisfied, the multiple available starting time domain locations of the slot including one or more starting time domain locations that are not aligned with any slot boundary.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of sidelink communications in accordance with the present disclosure.

FIG. 5 is a diagram illustrating an example of sidelink communications and access link communications in accordance with the present disclosure.

FIG. 6 is a diagram illustrating an example of sidelink communications in a shared or unlicensed frequency band in accordance with the present disclosure.

FIG. 7 is a diagram illustrating an example of channel access in a shared or unlicensed frequency band in accordance with the present disclosure.

FIG. 8 is a diagram illustrating an example of multiple starting points in a shared or unlicensed frequency band in accordance with the present disclosure.

FIG. 9 is a diagram of an example associated with conditional transmissions using additional starting positions for sidelink communications in accordance with the present disclosure.

FIG. 10 is a diagram of an example associated with conditional transmissions using additional starting positions for sidelink communications in accordance with the present disclosure.

FIG. 11 is a flowchart illustrating an example process performed, for example, by a UE that supports conditional transmissions using additional starting positions for unlicensed sidelink communications in accordance with the present disclosure.

FIG. 12 is a diagram of an example apparatus for wireless communication that supports conditional transmissions using additional starting positions for unlicensed sidelink communications in accordance with the present disclosure.

FIG. 13 is a diagram of an example apparatus for wireless communication that supports conditional transmissions using additional starting positions for unlicensed sidelink communications in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to a conditional use of additional starting positions (for example, associated with mini-slots) for sidelink communications. Some aspects more specifically relate to enabling a user equipment (UE) to optionally use additional starting positions or mini-slot-based scheduling for sidelink communications that are associated with a shared or unlicensed sidelink channel (or frequency band) based at least in part on whether one or more conditions are satisfied. In some aspects, the UE may perform one or more measurements associated with a channel access procedure for accessing the shared or unlicensed sidelink channel (for example, may perform a channel access procedure). The UE may transmit a sidelink communication based at least in part on the one or more measurements satisfying an energy detection threshold. A starting time domain location of the sidelink communication may be aligned with a slot boundary based at least in part on one or more conditions not being satisfied (for example, the UE may use slot-based scheduling based at least in part on one or more conditions not being satisfied). The starting time domain location may not be aligned with any slot boundary based at least in part on the one or more conditions being satisfied (for example, the UE may use mini-slot-based scheduling based at least in part on one or more conditions being satisfied). In other words, the UE may conditionally use mini-slot-based scheduling for the sidelink communication based at least in part on the one or more conditions being satisfied.

In some aspects, the one or more conditions may include a condition associated with a cast type of the sidelink communication (for example, where the condition indicates one or more cast types for which sidelink transmissions are not permitted to use the multiple available starting time domain locations or indicates one or more cast types for which sidelink transmissions are permitted to use the multiple available starting time domain locations). Additionally or alternatively, the one or more conditions may include a condition associated with a failure rate of the channel access procedure (for example, where the condition is satisfied based at least in part on the failure rate satisfying a threshold). Additionally or alternatively, the one or more conditions may include a condition associated with a priority value that is associated with the sidelink communication (for example, where the condition is satisfied based at least in part on the priority value satisfying a threshold). Additionally or alternatively, the one or more conditions may include a condition associated with a bandwidth size of the sidelink communication (for example, where the condition is satisfied based at least in part on the bandwidth size of the sidelink communication occupying a full bandwidth size associated with the shared or unlicensed sidelink channel). As described in more detail elsewhere herein, other conditions associated with a use of multiple starting locations or mini-slot-based scheduling are contemplated.

Particular aspects of the subject matter described in this disclosure can be implemented to realize one or more of the following potential advantages. In some examples, the described techniques can be used to improve a likelihood that a UE is able to access a shared or unlicensed sidelink channel by increasing a quantity of starting time domain locations available for sidelink communications, thereby reducing a delay between a time at which the UE detects that the shared or unlicensed sidelink channel is idle and a next available starting time domain location. Additionally, by restricting the use of the multiple available starting time domain locations or mini-slot-based scheduling to certain scenarios (for example, when the one or more conditions are satisfied), a decoding complexity or power consumption of UEs associated with using the multiple available starting time domain locations or mini-slot-based scheduling may not be needlessly increased. Further, the UE transmitting sidelink communications using the multiple available starting time domain locations or mini-slot-based scheduling only when the one or more conditions are satisfied may reduce a likelihood of a receiving UE experiencing an automatic gain control (AGC) problem (for example, based on using an inappropriate gain value, as explained in more detail elsewhere herein). For example, the one or more conditions may ensure that the UE uses the multiple available starting time domain locations or mini-slot-based scheduling only when the UE has reserved resources over a full slot or when the sidelink communication uses a full bandwidth of the shared or unlicensed sidelink channel (for example, thereby ensuring that the receiving UE will not receive other sidelink communications at a time that overlaps with the sidelink communication).

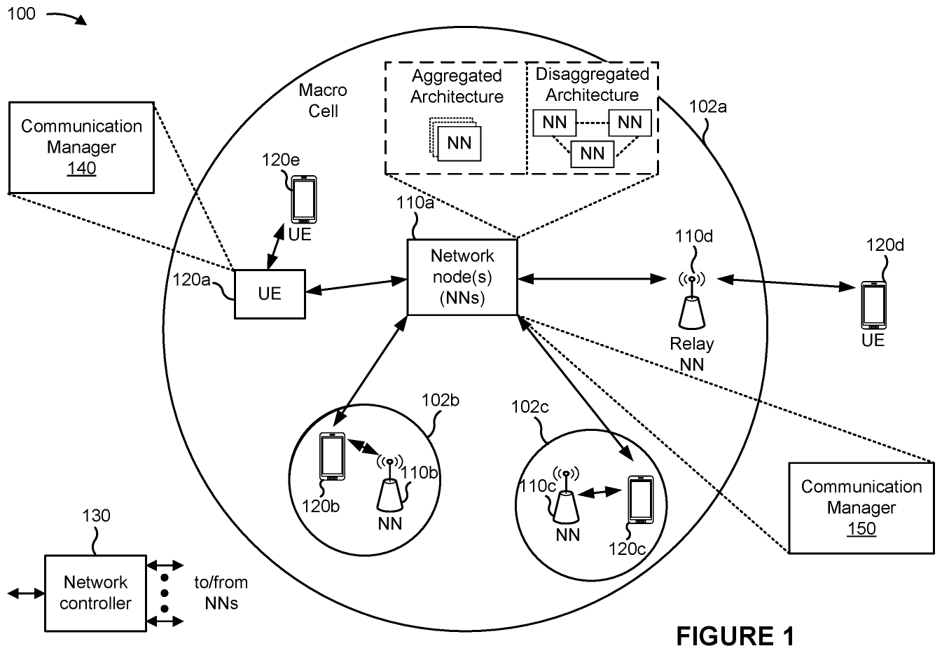

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular radio access technology (RAT) and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 /is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may perform one or more measurements associated with a channel access procedure for accessing a shared or unlicensed sidelink channel; and transmit, based at least in part on the one or more measurements satisfying an energy detection threshold, a sidelink communication at a starting time domain location that is aligned with a boundary of a slot based at least in part on one or more conditions not being satisfied, or that is one of multiple available starting time domain locations of the slot based at least in part on the one or more conditions being satisfied, the multiple available starting time domain locations of the slot including one or more starting time domain locations that are not aligned with any slot boundary. Additionally or alternatively, the communication manager 140 may perform one or more other operations described herein.

In some aspects, the network node 110 may include a communication manager 150. As described in more detail elsewhere herein, the communication manager 150 may transmit configuration information intended for a UE indicating one or more conditions associated with using multiple available starting time domain locations or multi-slot-based scheduling in a shared or unlicensed frequency band. Additionally or alternatively, the communication manager 150 may perform one or more other operations described herein.

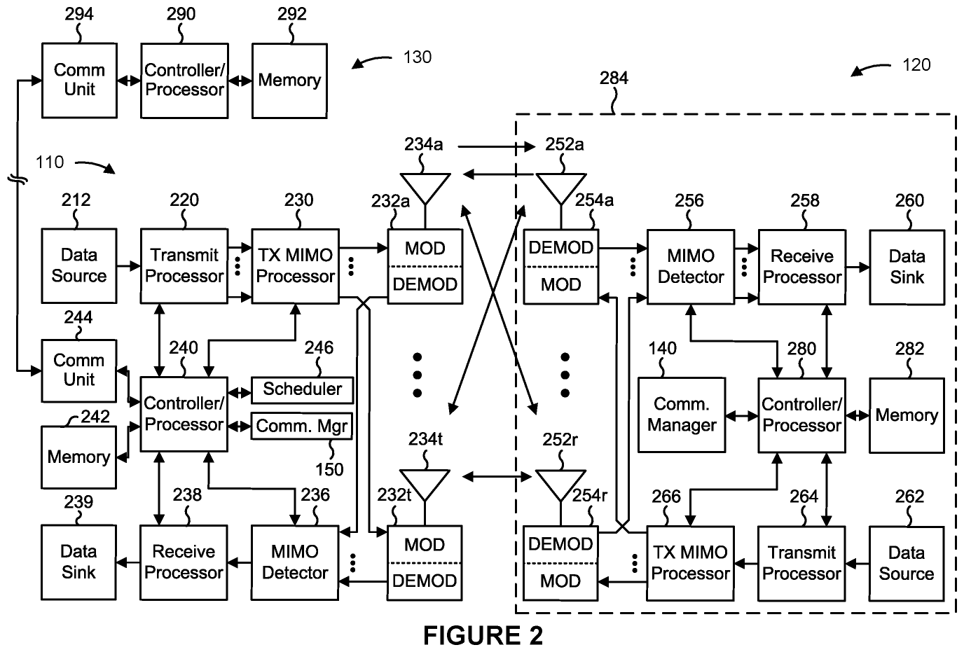

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

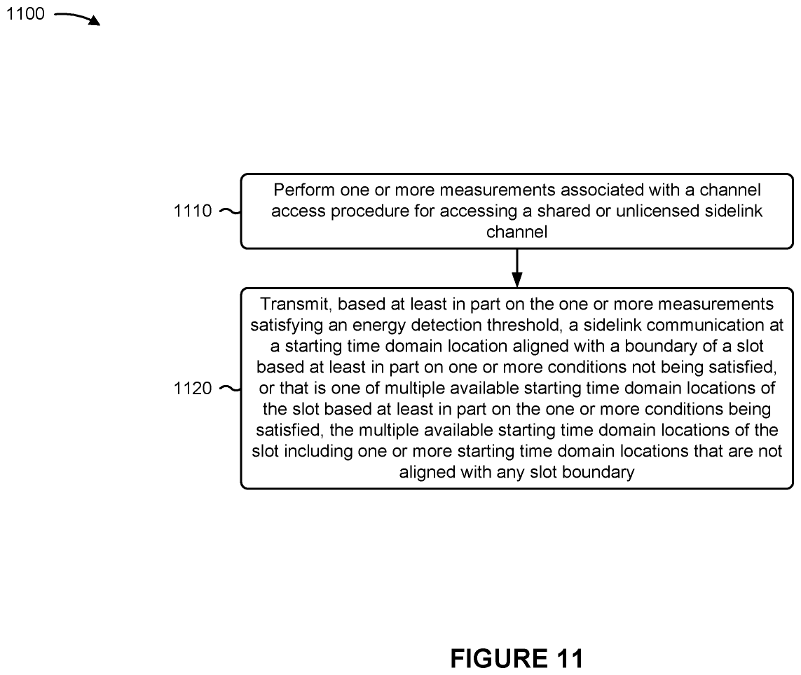

The controller/processor 240 of the network node 110, the controller/processor 280 of the UE 120, or any other component(s) of FIG. 2 may perform one or more techniques associated with conditional transmissions using additional starting positions for unlicensed sidelink communications, as described in more detail elsewhere herein. For example, the controller/processor 240 of the network node 110, the controller/processor 280 of the UE 120, or any other component(s) of FIG. 2 may perform or direct operations of, for example, process 1100 of FIG. 11, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1100 of FIG. 11, or other processes as described herein. In some examples, executing instructions may include running the instructions, converting the instructions, compiling the instructions, or interpreting the instructions, among other examples.

In some aspects, the UE 120 includes means for performing one or more measurements associated with a channel access procedure for accessing a shared or unlicensed sidelink channel; or means for transmitting, based at least in part on the one or more measurements satisfying an energy detection threshold, a sidelink communication at a starting time domain location that is aligned with a boundary of a slot based at least in part on one or more conditions not being satisfied, or that is one of multiple available starting time domain locations of the slot based at least in part on the one or more conditions being satisfied, the multiple available starting time domain locations of the slot including one or more starting time domain locations that are not aligned with any slot boundary. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

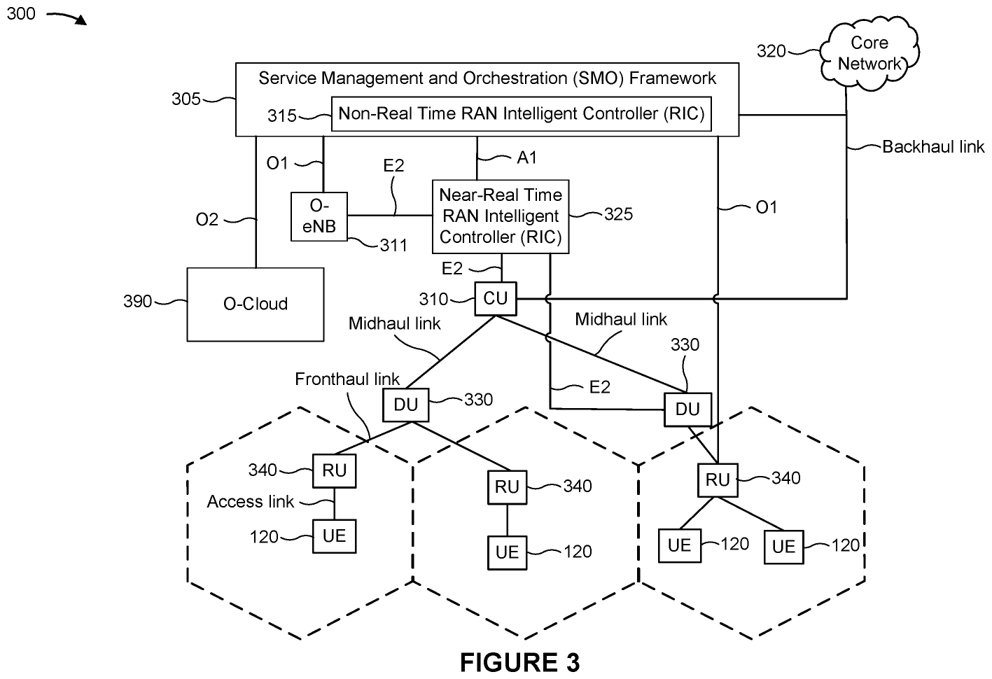

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

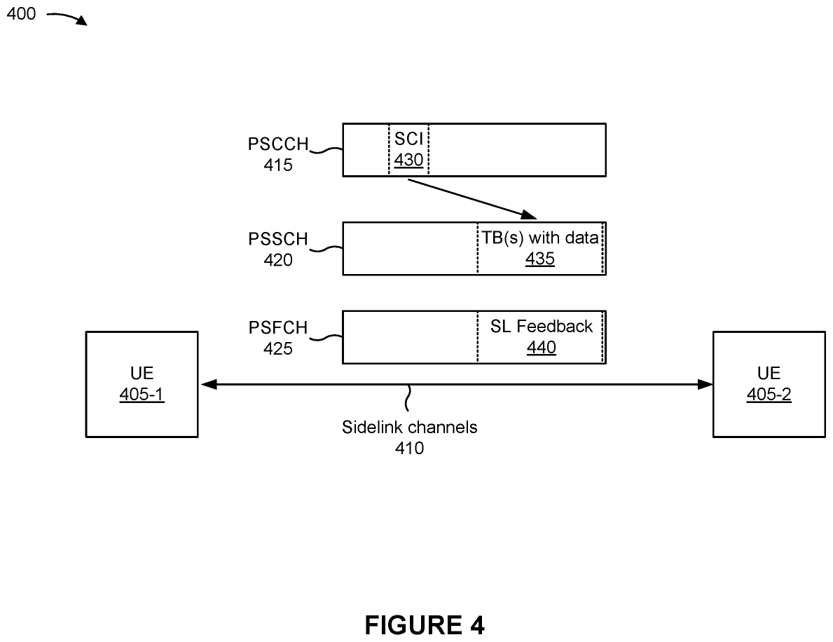

FIG. 4 is a diagram illustrating an example of sidelink communications 400 in accordance with the present disclosure. As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (for example, which may include V2V communications, V2I communications, or V2P communications) or mesh networking. In some examples, the UEs 405 (for example, UE 405-1 or UE 405-2) may correspond to one or more other UEs described elsewhere herein, such as UE 120. In some examples, the one or more sidelink channels 410 may use a PC5 interface or may operate in a high frequency band (for example, the 5.9 GHz band). Additionally or alternatively, the UEs 405 may synchronize timing of transmission time intervals (TTIs) (for example, frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, or a physical sidelink feedback channel (PSFCH) 425. The PSCCH 415 may be used to communicate control information, similar to a physical downlink control channel (PDCCH) or a physical uplink control channel (PUCCH) used for cellular communications with a network node 110 via an access link or an access channel. The PSSCH 420 may be used to communicate data, similar to a physical downlink shared channel (PDSCH) or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (for example, time resources, frequency resources, or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (for example, acknowledgement or negative acknowledgement (ACK/NACK) information), transmit power control (TPC), or a scheduling request (SR).

Although shown on the PSCCH 415, in some examples, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (for example, time resources, frequency resources, or spatial resources) on the PSSCH 420, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, or a modulation and coding scheme (MCS). The SCI-2 may include information associated with data transmissions on the PSSCH 420, such as a HARQ process ID, a new data indicator (NDI), a source identifier, a destination identifier, or a channel state information (CSI) report trigger.

In some examples, the one or more sidelink channels 410 may use resource pools. For example, a scheduling assignment (for example, included in SCI 430) may be transmitted in sub-channels using specific resource blocks (RBs) across time. In some examples, data transmissions (for example, on the PSSCH 420) associated with a scheduling assignment may occupy adjacent RBs in the same subframe as the scheduling assignment (for example, using frequency division multiplexing). In some examples, a scheduling assignment and associated data transmissions are not transmitted on adjacent RBs.

In some examples, a UE 405 may operate using a sidelink transmission mode (for example, Mode 1) where resource selection or scheduling is performed by a network node 110 (for example, a base station, a CU, or a DU). For example, the UE 405 may receive a grant (for example, in downlink control information (DCI) or in a RRC message, such as for configured grants) from the network node 110 (for example, directly or via one or more network nodes) for sidelink channel access or scheduling. In some examples, a UE 405 may operate using a transmission mode (for example, Mode 2) where resource selection or scheduling is performed by the UE 405 (for example, rather than a network node 110). In some examples, the UE 405 may perform resource selection or scheduling by sensing channel availability for transmissions. For example, the UE 405 may measure a received signal strength indicator (RSSI) parameter (for example, a sidelink-RSSI (S-RSSI) parameter) associated with various sidelink channels, may measure a reference signal received power (RSRP) parameter (for example, a PSSCH-RSRP parameter) associated with various sidelink channels, or may measure a reference signal received quality (RSRQ) parameter (for example, a PSSCH-RSRQ parameter) associated with various sidelink channels, and may select a channel for transmission of a sidelink communication based at least in part on the measurement(s).

Additionally or alternatively, the UE 405 may perform resource selection or scheduling using SCI 430 received in the PSCCH 415, which may indicate occupied resources or channel parameters. Additionally or alternatively, the UE 405 may perform resource selection or scheduling by determining a channel busy ratio (CBR) associated with various sidelink channels, which may be used for rate control (for example, by indicating a maximum quantity of resource blocks that the UE 405 can use for a particular set of subframes).

In the transmission mode where resource selection or scheduling is performed by a UE 405, the UE 405 may generate sidelink grants, and may transmit the grants in SCI 430. A sidelink grant may indicate, for example, one or more parameters (for example, transmission parameters) to be used for an upcoming sidelink transmission, such as one or more resource blocks to be used for the upcoming sidelink transmission on the PSSCH 420 (for example, for TBs 435), one or more subframes to be used for the upcoming sidelink transmission, or a modulation and coding scheme (MCS) to be used for the upcoming sidelink transmission. In some examples, a UE 405 may generate a sidelink grant that indicates one or more parameters for semi-persistent scheduling (SPS), such as a periodicity of a sidelink transmission. Additionally or alternatively, the UE 405 may generate a sidelink grant for event-driven scheduling, such as for an on-demand sidelink message.

In some examples, sidelink communications may be associated with slot-based scheduling. Slot-based scheduling may use a slot as a minimum time unit for resource scheduling in the time domain (for example, a minimum amount of time that can be reserved for a sidelink communication is a slot). In some other examples, sidelink communications may be associated with mini-slot-based scheduling, which may also be referred to as multiple starting position (or multiple starting location) based scheduling. A mini-slot may include a lesser quantity of symbols than a quantity of OFDM symbols included in a slot. For example, a starting location of a mini-slot may occur 1, 2, 4, 7, or another quantity of OFDM symbols after a start of a slot. A mini-slot may be positioned asynchronously with the start of a slot (for example, a start of a mini-slot may not align with a slot boundary). In some other examples, a start of a mini-slot may align with a slot boundary. A mini-slot may be a unit of scheduling that is smaller than a slot (for example, a mini-slot may be a portion of a slot). In some examples, a mini-slot may include one or more data symbols that represent data. Additionally or alternatively, the mini-slot may include one or more control symbols that represent control information associated with the mini-slot. In some examples, the one or more control symbols may be at or near a beginning of the mini-slot (for example, in the first two symbols of the mini-slot) or at or near an end of the mini-slot (for example, in the last symbol of the mini-slot). Alternatively, the mini-slot may not include a control symbol.

Using mini-slot-based scheduling for sidelink communications may increase a flexibility for reserving sidelink resources or may reduce a latency associated with sidelink communication. However, mini-slot-based scheduling may be associated with increased signaling overhead because more granular resource reservations may be made, thereby resulting in an increased quantity of resource reservations being transmitted in the sidelink network.

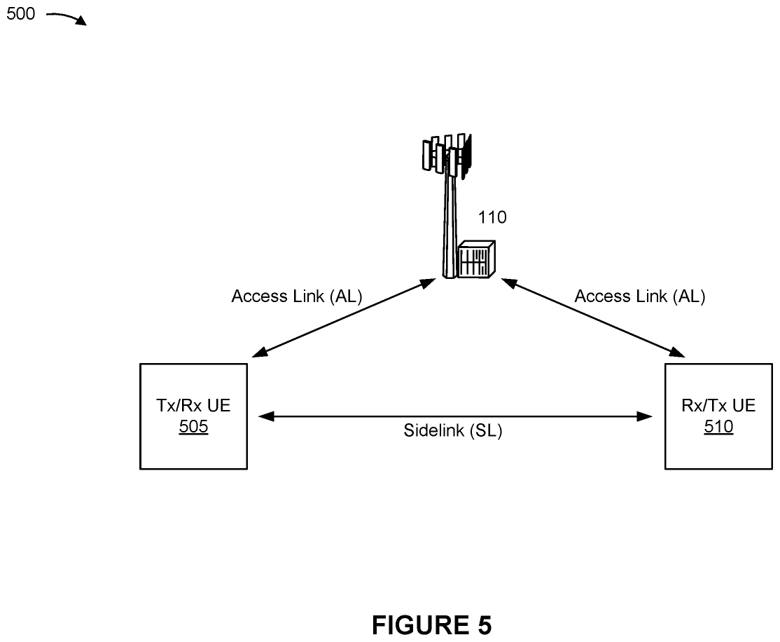

FIG. 5 is a diagram illustrating an example 500 of sidelink communications and access link communications in accordance with the present disclosure. As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (for example, directly or via one or more network nodes), such as via a first access link. Additionally or alternatively, in some sidelink modes, the network node 110 may communicate with the Rx/Tx UE 510 (for example, directly or via one or more network nodes), such as via a first access link. The Tx/Rx UE 505 or the Rx/Tx UE 510 may correspond to one or more UEs described elsewhere herein, such as the UE 120 of FIG. 1. Thus, a direct link between UEs 120 (for example, via a PC5 interface) may be referred to as a sidelink, and a direct link between a network 110 and a UE 120 (for example, via a Uu interface) may be referred to as an access link. Sidelink communications may be transmitted via the sidelink (for example, via a PC5 interface), and access link communications may be transmitted via the access link (for example, via a Uu link). An access link communication may be either a downlink communication (from a network node 110 to a UE 120) or an uplink communication (from a UE 120 to a network node 110).

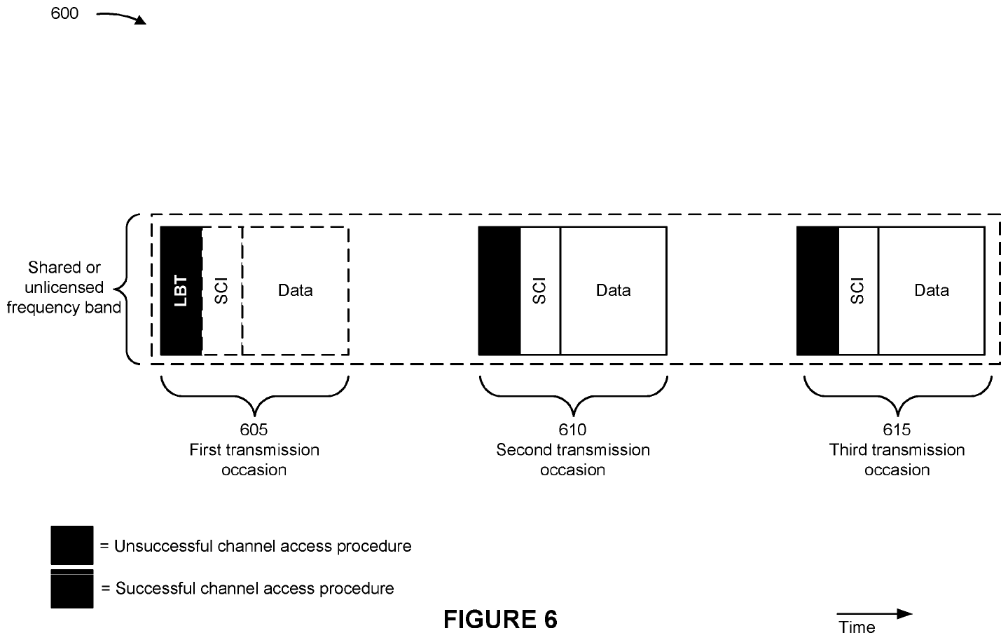

FIG. 6 is a diagram illustrating an example of sidelink communications 600 in a shared or unlicensed frequency band in accordance with the present disclosure. Various techniques may be used to increase data rates associated with sidelink networks. For example, some wireless network may support carrier aggregation for sidelink communication. As another example, some wireless network may support sidelink communications via unlicensed frequency bands or shared frequency bands (for example, an unlicensed or shared frequency spectrum), thereby providing additional frequency domain resources that are available to be used for sidelink communications. A shared or unlicensed frequency band may be a frequency band that is associated with non-exclusive usage associated with various operators, devices, or RATs, among other examples.

For example, in a shared or unlicensed frequency band, devices using different RATs may communicate using the same frequency band (for example, the same channel). For the two different type of devices (for example, using different RATs) to coexist while using a common carrier frequency, there is a need for a mechanism to efficiently utilize resource allocation by the two RATs without negatively impacting the operation of each RAT. For example, in a shared or unlicensed frequency band, a transmitting device may contend against other devices for channel access before transmitting on a shared or unlicensed channel to reduce or prevent collisions on the shared or unlicensed channel. To contend for channel access, the transmitting device may perform a channel access procedure, such as a listen-before-talk (or listen-before-transmit) (LBT) procedure or another type of channel access procedure, for shared or unlicensed frequency band channel access. The channel access procedure may be performed to determine whether the physical channel (for example, the radio resources of the channel) are free to use or are busy (for example, in use by another wireless communication device such as a UE, an IoT device, or a wireless local area network (WLAN) device, among other examples).

The channel access procedure may include sensing or measuring the physical channel (for example, performing an RSRP measurement, detecting an energy level, or performing another type of measurement) during a channel access gap (which may also be referred to as a contention window (CW)) and determining whether the shared or unlicensed channel is free or busy based at least in part on the signals sensed or measured on the physical channel (for example, based at least in part on whether the measurement satisfies a threshold, such as an energy detection threshold). If the transmitting device determines that the channel access procedure was successful (for example, if the measurement(s) of the physical channel satisfies the energy detection threshold), then the transmitting device may perform one or more transmissions on the shared or unlicensed channel during a transmission opportunity, which may extend for a channel occupancy time (COT). If the transmitting device determines that the channel access procedure was unsuccessful (for example, if the measurement(s) of the physical channel do not satisfy the energy detection threshold), then the transmitting device may refrain from performing one or more transmissions on the shared or unlicensed channel.

For example, as shown in FIG. 6, a UE 120 may attempt to transmit a sidelink communication (for example, sidelink data or a sidelink TB) using a first transmission occasion 605. A transmission occasion may be time-frequency resources in which a UE (or another wireless communication device) has an opportunity to transmit a signal. “Transmission occasion” and “transmission opportunity” may be used interchangeably herein. The UE 120 may perform a channel access procedure (for example, shown in FIG. 6 as an LBT procedure as an example) prior to transmitting the sidelink communication. As shown in FIG. 6, the channel access procedure may be unsuccessful (for example, the shared or unlicensed frequency band may be busy). As a result, the UE 120 may refrain from transmitting the sidelink communication using the first transmission occasion 605.

As shown in FIG. 6, the UE 120 may be associated with a second transmission occasion 610 or a third transmission occasion 615. For example, in some cases, based at least in part on being unable to transmit the sidelink communication using the first transmission occasion 605 (for example, due to the failed channel access procedure), the UE 120 may transmit, to a network node 110, a request for additional time-frequency resources to be used to transmit a retransmission of the sidelink communication. The network node 110 may transmit an indication of the second transmission occasion 610 or the third transmission occasion 615 to the UE 120 (for example, directly or via one or more network nodes). This may consume additional radio resources and signaling overhead associated with the UE 120 transmitting a request for the additional resources and the network node 110 transmitting a grant indicating the additional resources.

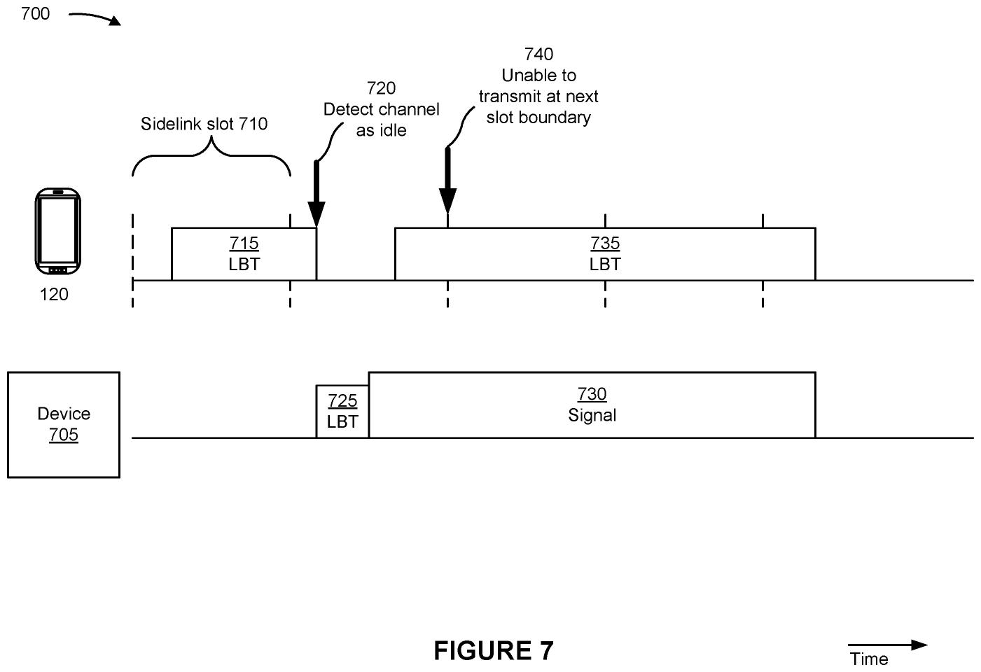

FIG. 7 is a diagram illustrating an example of channel access 700 in a shared or unlicensed frequency band in accordance with the present disclosure. As shown in FIG. 7, a UE 120 may communicate in a shared or unlicensed frequency band. For example, the UE 120 may communicate one or more sidelink signals in the shared or unlicensed frequency band. As shown in FIG. 7, the UE 120 may be configured with one or more sidelink slots 710. For example, the UE 120 may use slot-based scheduling to transmit or receive the one or more sidelink signals. In other words, UE 120 may only transmit signals starting at slot boundaries.

One or more other devices, such as a device 705, may operate in the shared or unlicensed frequency band. The device 705 may be associated with a different RAT (for example, different than a RAT used by the UE 120), a different slot format, a different transmission timing, or a different scheduling technique, among other examples (for example, as compared to the UE 120). For example, the device 705 may be associated with an asynchronous transmission timing (for example, the device may not have to wait for scheduling to transmit signals).

In a first operation 715, the UE 120 may perform a channel access procedure, such as an LBT procedure (for example, in a similar manner as described in more detail elsewhere herein, such as in connection with FIG. 6). In a second operation 720, the UE 120 may detect that the channel (for example, the shared or unlicensed frequency band) is idle (for example, based at least in part on the channel access procedure being successful). However, a timing of the UE 120 detecting that the channel is idle may occur in a middle for a sidelink slot 710. In other words, a timing of the UE 120 detecting that the channel (for example, the shared or unlicensed frequency band) is idle may be arbitrary (for example, may occur at any time). However, the UE 120 may need to wait until a next sidelink slot 710 (for example, until a next slot boundary) to transmit a sidelink communication. For example, because sidelink communications are synchronous, the timing of a transmission of the sidelink communication may be defined as a start of sidelink slot 710. Therefore, the UE 120 may wait (for example, after detecting that the channel is idle) until a next slot to transmit a sidelink communication.

However, in a time between when the UE 120 detects that the channel is idle and a start of a next slot, the device 705 may sense the channel (for example, as idle) and begin a transmission of a signal. For example, in a third operation 725, the device 705 may perform a channel access procedure. The device 705 may detect that the channel (for example, the shared or unlicensed frequency band) is idle (for example, because the UE 120 is waiting until the next slot to transmit a sidelink signal). Therefore, in a fourth operation 730, the device 705 may transmit a signal. Because the device 705 may be an asynchronous device or may be associated with a different slot format or different slot timing than the UE 120, the device 705 may begin a transmission of the signal (for example, in the fourth operation 730) prior to a start of the next sidelink slot 710.

In a fifth operation 735, the UE 120 may perform a channel access procedure (for example, an LBT procedure) shortly before (for example, one or more OFDM symbols before) the start of the next sidelink slot 710 to ensure that the channel is still idle. However, because the device 705 may have begun transmitting a signal on the channel (for example, in the fourth operation 730), the UE 120 (for example, in the fifth operation 735) may detect that the channel is busy. As a result, in a sixth operation 740, the UE 120 may refrain from transmitting a sidelink signal at the next slot boundary. In other words, the UE 120 may be unable to transmit at a next slot boundary due to the signal transmitted by the device 705. Because the UE 120 delays a transmission of a sidelink signal until the next sidelink slot 710 after detecting that the channel is idle (for example, in the second operation 720), the UE 120 may lose a transmission opportunity. This may increase latency associated with sidelink signals transmitted in the shared or unlicensed frequency band.

This problem may be prevalent in sidelink configurations associated with low subcarrier spacing (SCS), such as 15 kHz or 30 kHz, among other examples (for example, because a slot duration may be longer with a lower SCS). For example, a slot duration for an SCS of 15 kHz may be approximately 72 microseconds and a slot duration for an SCS of 30 kHz may be approximately 36 microseconds. In some examples, a channel access procedure (such as an LBT procedure) may be completed in as fast as 16 microseconds. Therefore, in the low SCS scenarios, another device (such as the device 705) may complete a channel access procedure while the UE 120 is waiting for a next sidelink slot 710.

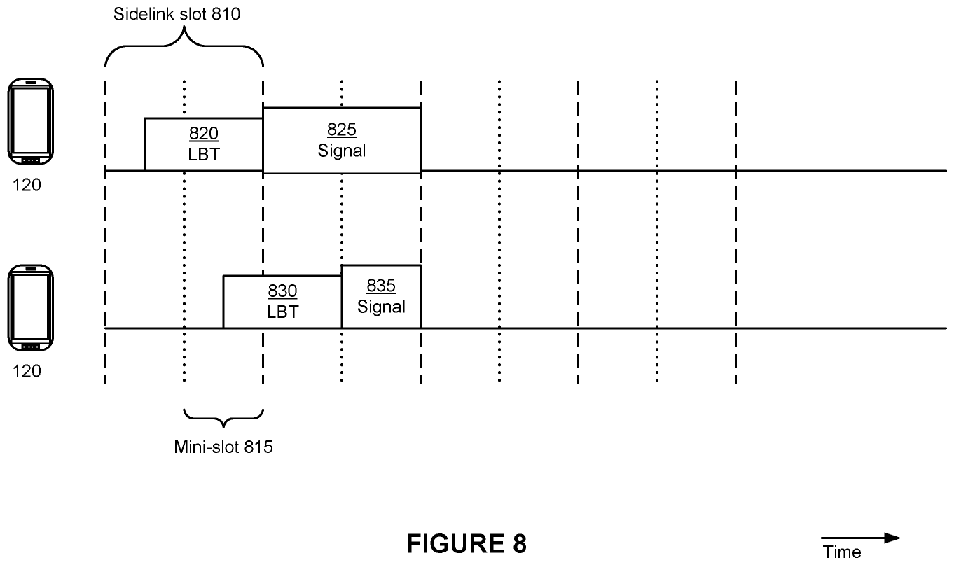

FIG. 8 is a diagram illustrating an example of multiple starting points in a shared or unlicensed frequency band in accordance with the present disclosure. As shown in FIG. 8, a sidelink configuration may be associated with multiple starting locations for sidelink transmissions (for example, in addition to slot boundaries). The multiple starting locations may be associated with mini-slots. For example, where a sidelink configuration is associated with multiple starting locations for sidelink transmissions, a UE 120 may be enabled to start a transmission of a sidelink signal at a start of a sidelink slot 810 or at a start of a mini-slot 815. For example, in some cases, mini-slot scheduling may be used to reduce a delay between a time at which a UE 120 detects an idle channel (for example, based on performing an LBT procedure) and a next transmission opportunity by providing additional starting locations for sidelink communications (for example, in addition to a start of a slot, the UE 120 may transmit a sidelink communication at a start of a mini-slot).

In some examples, a receiving UE may perform automatic gain control (AGC). For example, a slot may include fourteen OFDM symbols and at least one OFDM symbol (for example, a first OFDM symbol in the slot) may be dedicated for AGC training at a receiving UE. The AGC symbol may be received by the receiving UE, which may configure a gain for one or more receive components (for example, of the receiving UE) based on one or more signal characteristics (for example, a received signal power) associated with the AGC symbol. Accordingly, when the transmitting UE transmits sidelink data in the remaining symbols or slots that are subsequent in time relative to the AGC symbol, the receiving UE may apply the configured gain to process the sidelink data.

In a first operation 820, a first UE 120 may perform a channel access procedure (for example, an LBT procedure). The first UE 120 may detect that the channel (for example, the shared or unlicensed frequency band) is idle based at least in part on performing the channel access procedure. Therefore, the first UE 120 may transmit a signal 825. The signal may be a slot-based signal (for example, may be at a start of a sidelink slot). A receiving UE (not shown in FIG. 8) may perform an AGC operation based at least in part on a symbol of the signal 825 (for example, a first (in time) one or more symbols of the signal 825).

In a second operation 830, a second UE 120 may perform a channel access procedure (for example, an LBT procedure). The first UE 120 may detect that the channel (for example, the shared or unlicensed frequency band) is idle. For example, the first UE 120 may not detect or measure the signal 825 (for example, due to a blockage or other obstruction causing the signal 825 to be hidden from the second UE 120). Therefore, the second UE 120 may transmit a signal 835. The signal 835 may begin at a starting location that is included in the slot associated with the signal 825. For example, the signal 835 may occupy a mini-slot that is included in the slot in which the signal 825 is transmitted.

In some cases, the receiving UE (for example, that is receiving the signal 825) may also receive the signal 835 (for example, the receiving UE may be located geographically or spatially such that the receiving UE also receives the signal 835). However, because the receiving UE may be applying a gain control that is based on a received power of the signal 825 (for example, and not the signal 835), the additional received power caused by the receiving UE receiving the signal 835 may degrade a reception of the signal 825 (for example, may cause saturation of one or more front end components of the receiving UE). Therefore, the introduction of mini-slots or additional (multiple) starting locations for sidelink signals may introduce problems for AGC performed by receiving UEs.

Additionally or alternatively, the introduction of mini-slots or additional (multiple) starting locations for sidelink signals may introduce additional decoding complexity. For example, UEs in a sidelink network associated with mini-slot-based scheduling may perform additional blind decoding attempts for additional transmission opportunities introduced by the mini-slots. For example, a resource pool may include resources associated with a given transmission opportunity. For slot-based scheduling, a resource pool may include resources associated with a given slot. For mini-slot-based scheduling, a resource pool may include resources associated with a given mini-slot. Therefore, if a mini-slot is a quarter of a size of a slot, then a receiving UE may perform 4 times as many decoding attempts when using mini-slot-based scheduling as compared to slot-based scheduling.

Various aspects relate generally to conditional transmissions using additional starting positions (for example, associated with mini-slots) for sidelink communications. Some aspects more specifically relate to enabling a UE to use additional starting positions or mini-slot-based scheduling for sidelink communications that are associated with a shared or unlicensed sidelink channel (or frequency band) based at least in part on whether one or more conditions are satisfied. In some aspects, the UE may perform one or more measurements associated with a channel access procedure for accessing the shared or unlicensed sidelink channel (for example, may perform a channel access procedure). The UE may transmit a sidelink communication based at least in part on the one or more measurements satisfying an energy detection threshold. A starting time domain location of the sidelink communication may be aligned with a slot boundary based at least in part on one or more conditions not being satisfied (for example, the UE may use slot-based scheduling based at least in part on one or more conditions not being satisfied). The starting time domain location of the sidelink communication may be included in multiple available starting time domain locations that include one or more starting time domain locations that are not aligned with any slot boundary based at least in part on the one or more conditions being satisfied. In other words, the UE may use mini-slot-based scheduling for the sidelink communication based at least in part on the one or more conditions being satisfied.

In some aspects, the one or more conditions may include a condition associated with a cast type of the sidelink communication (for example, where the condition indicates one or more cast types for which sidelink transmissions are not permitted to use the multiple available starting time domain locations, or indicates one or more cast types for which sidelink transmissions are permitted to use the multiple available starting time domain locations). Additionally or alternatively, the one or more conditions may include a condition associated with a failure rate of the channel access procedure (for example, where the condition is satisfied based at least in part on the failure rate satisfying a threshold). Additionally or alternatively, the one or more conditions may include a condition associated with a priority value that is associated with the sidelink communication (for example, where the condition is satisfied based at least in part on the priority value satisfying a threshold). Additionally or alternatively, the one or more conditions may include a condition associated with a bandwidth size of the sidelink communication (for example, where the condition is satisfied based at least in part on the bandwidth size of the sidelink communication occupying a full bandwidth size associated with the shared or unlicensed sidelink channel). As described in more detail elsewhere herein, other conditions associated with a use of multiple starting locations or mini-slot-based scheduling are contemplated.

Particular aspects of the subject matter described in this disclosure can be implemented to realize one or more of the following potential advantages. In some examples, the described techniques can be used to improve a likelihood that a UE is able to access the shared or unlicensed sidelink channel by increasing a quantity of starting time domain locations available for sidelink communications, thereby reducing a delay between a time at which the UE detects that the shared or unlicensed sidelink channel is idle and a next available starting time domain location. Additionally, by restricting the use of the multiple available starting time domain locations or mini-slot-based scheduling to certain scenarios (for example, when the one or more conditions are satisfied), a decoding complexity or power consumption of UEs associated with using the multiple available starting time domain locations or mini-slot-based scheduling may not be needlessly increased. Further, the UE transmitting sidelink communications using the multiple available starting time domain locations or mini-slot-based scheduling only when the one or more conditions are satisfied may reduce a likelihood of a receiving UE experiencing an AGC issue (for example, using an inappropriate power gain value, as explained in more detail elsewhere herein). For example, the one or more conditions may ensure that the UE uses the multiple available starting time domain locations or mini-slot-based scheduling only when the UE has reserved resources over a full slot or when the sidelink communication uses a full bandwidth of the shared or unlicensed sidelink channel (for example, thereby ensuring that the receiving UE will not receive other sidelink communications at a time that overlaps with the sidelink communication).

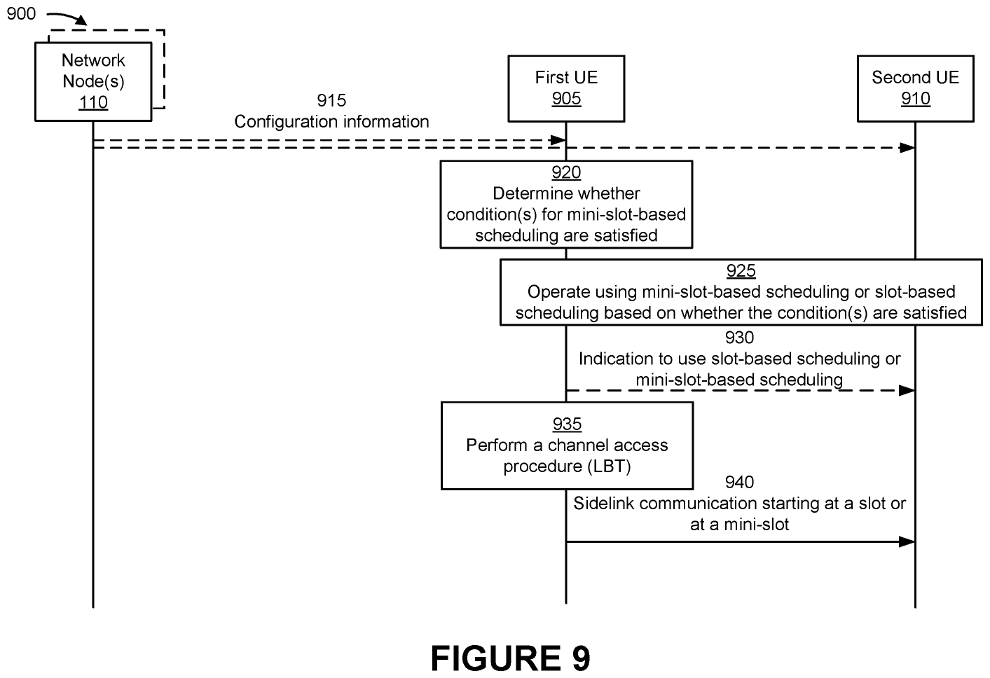

FIG. 9 is a diagram of an example associated with conditional transmissions using additional starting positions for sidelink communications 900 in accordance with the present disclosure. As shown in FIG. 9, one or more network nodes 110 (for example, a CU, a DU, an RU, or a base station) may communicate with a first UE 905 (for example, a first UE 120) and a second UE 910 (for example, a second UE 120). In some aspects, the network node(s) 110, the first UE 905, and the second UE 910 may be part of a wireless network (for example, the wireless network 100). The first UE 905 and the network node 110 may have established a wireless connection prior to operations shown in FIG. 9. Similarly, the second UE 910 and the network node 110 may have established a wireless connection prior to operations shown in FIG. 9. The first UE 905 and the second UE 910 may communicate with each other using a sidelink (for example, in a similar manner as described in connection with FIGS. 4 and 5).

The first UE 905 and the second UE 910 may be operating in an unlicensed or shared sidelink channel (for example, in an unlicensed or shared frequency band). In some aspects, the first UE 905 and the second UE 910 may communicate via an unlicensed or shared sidelink frequency band (for example, sometimes referred to as a sidelink unlicensed (SL-U) frequency band). For example, the first UE 905 and the second UE 910 may communicate via one or more SL-U procedures (for example, as defined, or otherwise fixed, by a wireless communication standard, such as the 3GPP).

As used herein, the network node 110 “transmitting” a communication to a UE 120 (for example, the first UE 905 or the second UE 910) may refer to a direct transmission (for example, from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, a UE 120 (for example, the first UE 905 or the second UE 910) “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU. References herein to “a network node 110” or “the network node 110” can, in some aspects, refer to multiple network nodes.

In some aspects, in a first operation 915, the network node 110 may transmit, and the first UE 905 or the second UE 910 may receive, configuration information. In some aspects, the first UE 905 or the second UE 910 may receive the configuration information via one or more of RRC signaling, one or more medium access control (MAC) control elements (MAC-CEs), or DCI, among other examples. In some aspects, the configuration information may include an indication of one or more configuration parameters for selection by the first UE 905 or the second UE 910, or explicit configuration information for the first UE 905 or the second UE 910 to use to configure itself, among other examples. The first UE 905 or the second UE 910 may receive the configuration information via a Uu interface or an access link.

In some aspects, the configuration information may be associated with a sidelink configuration. For example, the first UE 905 or the second UE 910 may be configured to perform one or more operations described herein associated with a sidelink or PC5 interface. In some aspects, the configuration information may be, or may be associated with, an SL-U configuration. For example, the first UE 905 or the second UE 910 may be configured to perform one or more operations described herein via a shared or unlicensed frequency band. For example, the configuration information may indicate one or more shared or unlicensed frequency bands to be used by the first UE 905 or the second UE 910 for sidelink communications. Additionally or alternatively, the configuration information may indicate one or more resource pool configurations to be used by the first UE 905 or the second UE 910 for sidelink communications.

In some aspects, the configuration information may indicate that the first UE 905 or the second UE 910 may conditionally use multiple available starting time domain locations or mini-slot-based scheduling for sidelink communications that are associated with a shared or unlicensed sidelink channel. For example, the configuration information may indicate one or more conditions that are to be met or satisfied in order for the first UE 905 or the second UE 910 to use multiple available starting time domain locations or mini-slot-based scheduling for the sidelink communications. The configuration information may indicate that if the one or more conditions are satisfied, then the first UE 905 or the second UE 910 may use the multiple available starting time domain locations or mini-slot-based scheduling (for example, may be permitted to use starting time domain locations that do not align with a slot boundary). The configuration information may indicate that if the one or more conditions are not satisfied, then the first UE 905 or the second UE 910 may not use the multiple available starting time domain locations or mini-slot-based scheduling (for example, may be permitted to only use starting time domain locations that align with a slot boundary or may only use slot-based scheduling). The configuration information may indicate one or more (or all) of the condition(s) to be considered by the first UE 905 or the second UE 910, as described in more detail elsewhere herein.

As used herein, a “starting time domain location” may refer to a time at which a communication is first transmitted (for example, a first (or earliest) OFDM symbol in time associated with the communication). As described elsewhere herein, “multiple available starting time domain locations” may refer to multiple, or additional, opportunities for a UE (for example, the first UE 905 or the second UE 910) to initiate a sidelink communication (for example, in addition to configured slot boundaries). The multiple available starting time domain locations may be associated with mini-slot-based scheduling. For example, the multiple available starting time domain locations may include one or more starting time domain locations that are not aligned with slot boundaries. As an example, the multiple available starting time domain locations may be associated with mini-slots. For example, the multiple available starting time domain locations may include a start of slots (for example, configured sidelink slots) and a start of mini-slots. In other words, the multiple available starting time domain locations may be associated with one or more mini-slots.

In some aspects, the first UE 905 may transmit, and the network node 110 may receive, a capability report. The capability report may indicate that the first UE 905 supports sidelink communication in a shared or unlicensed channel or frequency band. Additionally, the capability report may indicate that the first UE 905 supports conditionally using multiple starting locations or mini-slot-based scheduling. The network node 110 may configure the first UE 905 to use the shared or unlicensed channel or frequency band or to conditionally use multiple starting locations or mini-slot-based scheduling based at least in part on receiving the capability report. The second UE 910 may transmit, and the network node 110 may receive, a capability report in a similar manner as described above.

The first UE 905 may configure itself based at least in part on the configuration information. In some aspects, the second UE 910 may configure itself based at least in part on the configuration information. In some aspects, the first UE 905 or the second UE 910 may be configured to perform one or more operations described herein based at least in part on the configuration information.

In a second operation 920, the first UE 905 may determine whether one or more conditions are satisfied. The second UE 910 may determine whether the one or more conditions are satisfied in a similar manner as described herein. The one or more conditions may be associated with a use (by the first UE 905) of multiple available starting time domain locations or mini-slot-based scheduling for sidelink communications in the shared or unlicensed frequency band. In some aspects, the one or more conditions may be indicated by the configuration information (for example, that is received by the first UE 905 in the first operation 915). Additionally or alternatively, an indication of one or more (or all) of the conditions may be stored by the first UE 905. For example, one or more (or all) of the conditions may be defined, or otherwise fixed, by a wireless communication standard, such as the 3GPP. In such examples, the one or more conditions may be stored by the first UE 905 (for example, as part of an original equipment manufacturer (OEM) configuration).

In some aspects, the one or more conditions may include a condition associated with a cast type of a sidelink communication. For example, the condition may indicate one or more cast types for which the first UE 905 is not permitted to use the multiple available starting time domain locations or mini-slot scheduling. In such examples, the condition is satisfied based at least in part on a cast type of the sidelink communication being included in the one or more cast types. In other words, mini-slot transmissions may not be allowed for certain cast types. The cast type(s) may include a one-to-many or one-to-all cast type, such as a broadcast or groupcast, among other examples. In some examples, the cast type(s) may include a groupcast associated with negative acknowledgment (NACK) only distance-based feedback (for example, which may be referred to as a groupcast Option 1). By not permitting the first UE 905 to use multiple available starting time domain locations or mini-slot scheduling for broadcast or certain groupcast transmissions, UEs that do not support the multiple available starting time domain locations or mini-slot scheduling may be enabled to receive the sidelink communication (for example, because the first UE 905 may be restricted to using slot-based scheduling, which may be supported by all UEs or a majority of UEs receiving the broadcast or certain groupcast transmissions). This may enable UEs that do not support the multiple available starting time domain locations or mini-slot scheduling to receive data from RRC connectionless links (for example, in a sidelink Mode 2 operating mode), which can be important for certain types of data that are typically transmitted using broadcast or groupcast transmissions, such as safety applications, among other examples.

In some aspects, the condition (for example, that is associated with cast types) may indicate one or more cast types for which the first UE 905 is permitted to use the multiple available starting time domain locations. In such examples, the condition may be satisfied if the cast type of a sidelink communication is included in the one or more cast types. For example, the condition may indicate that mini-slot transmissions can be optionally used by the first UE 905 (for example, subject to one or more other conditions described herein) only for certain transmission cast types. The one or more cast types for which the first UE 905 is permitted to use the multiple available starting time domain locations may include unicast or groupcast that is associated with HARQ acknowledgement (ACK) or NACK (ACK/NACK) feedback (for example, which may be referred to as groupcast Option 2), among other examples. For example, mini-slot transmissions may not be allowed for broadcast and groupcast Option 1 (for example, as described above), but may be optionally used by the first UE 905 for unicast and groupcast Option 2. This may enable RRC connected nodes (for example, the first UE 905 and the second UE 910) to optionally communicate via mini-slots. In some aspects, the one or more cast types for which the first UE 905 is permitted to use the multiple available starting time domain locations may be indicated in the configuration information received by the first UE 905 (for example, in the first operation 915) or stored by the first UE 905.

In some aspects, the first UE 905 may using the multiple available starting time domain locations or mini-slot-based scheduling subject to one or more other conditions described herein and based at least in part on one or more other UEs associated with a given sidelink communication supporting mini-slot-based scheduling. For example, the first UE 905 may receive, from the second UE 910, a capability report indicating whether the second UE 910 supports mini-slot-based scheduling. If the second UE 910 indicates support for mini-slot-based scheduling, then the first UE 905 may use the multiple available starting time domain locations or mini-slot-based scheduling subject to one or more other conditions described herein being satisfied. If the second UE 910 indicates that the second UE 910 does not support mini-slot-based scheduling, then the first UE 905 may use slot-based scheduling for communications associated with the second UE 910.

For example, the first UE 905 may determine to use multiple available starting time domain locations or mini-slot-based scheduling based at least in part on one or more conditions being satisfied (for example, even if a sidelink is associated with multiple available starting time domain locations or mini-slot-based scheduling) to avoid unnecessarily increasing power consumption of a receiving UE or a decoding complexity. For example, as described herein, the one or more conditions may reflect how dominant non-sidelink activity is on the shared or unlicensed frequency band (for example, that is used by the first UE 905 and the second UE 910). For example, if there is no, or little, non-sidelink activity on the shared or unlicensed frequency band, then there may be no need to use mini-slot-based scheduling because the sidelink communications may be adequately communicated using slot-based scheduling (for example, without introducing the drawbacks of mini-slot-based scheduling described elsewhere herein).

For example, the one or more conditions may include a condition associated with a failure rate of the channel access procedure (for example, an LBT procedure). For example, the first UE 905 may track the failure rate (for example, a quantity of channel access procedure failures over a given amount of time) associated with attempted sidelink transmissions on the shared or unlicensed frequency band. The failure rate may indicate how dominant non-sidelink activity is on the shared or unlicensed frequency band (for example, a higher failure rate may indicate that non-sidelink activity is more dominant or present on the shared or unlicensed frequency band). In such examples, the condition associated with the failure rate of the channel access procedure may be satisfied based at least in part on the failure rate satisfying a threshold.

In some aspects, the one or more conditions may include a condition associated with a channel busy ratio, associated with the shared or unlicensed frequency band, that is associated with one or more RATs other than a RAT used by the first UE 905. For example, the condition may be satisfied based at least in part on the channel busy ratio satisfying a threshold. The CBR may be a modified CBR that indicates other-RAT activity (for example, activity associated with RATs other than the RAT used by the first UE 905 or activity in addition to sidelink activity) on the shared or unlicensed frequency band. In some aspects, the first UE 905 may measure the channel busy ratio and determine whether the condition is satisfied (for example, whether the measured channel busy ratio satisfies a threshold).

In some aspects, a condition may be satisfied based at least in part the condition being satisfied for a quantity of UEs, including the UE, associated with a sidelink associated with the sidelink communication, where the quantity satisfies a threshold. In other words, the condition may be satisfied based at least in part on K out of a total of NUEs associated with the sidelink identifying or determining that the condition associated with the other-RAT channel busy ratio is satisfied (for example, where N is greater than or equal to two, and where K is greater than one and less than or equal to N). In some aspects, the N UEs (for example, the quantity of UEs) may be transmitting UEs associated with the sidelink. Additionally or alternatively, the NUEs (for example, the quantity of UEs) may be receiving UEs associated with the sidelink.

In some aspects, the one or more conditions may include a condition associated with a level or quantity of other-RAT activity on the shared or unlicensed frequency band. For example, the first UE 905 may include a module associated with a second RAT (such as a WiFi module) that is configured to measure activity associated with the second RAT on the shared or unlicensed frequency band. For example, if the module is a WiFi module, the WiFi module may detect a quantity of WiFi headers that are transmitted via the shared or unlicensed frequency band. If the quantity of WiFi headers satisfies a threshold, then the first UE 905 may determine that the condition is satisfied. In other words, if the WiFi module of the first UE 905 detects a large quantity of WiFi headers on the shared or unlicensed frequency band, then this may be an indication of significant other-RAT activity (for example, significant WiFi activity). The module associated with the second RAT may pass information associated with the level of activity associated with the second RAT on the shared or unlicensed frequency band to a module associated with the RAT used by the first UE 905 to communicate via the sidelink (for example, a 5G or NR module). The first UE 905 may include other modules associated with other RATs that are enabled to detect a level of activity of the other RATs on the shared or unlicensed frequency band in a similar manner. This may enable the module associated with the RAT used by the first UE 905 to communicate via the sidelink to identify or detect a level or quantity of other-RAT activity on the shared or unlicensed frequency band.

In some aspects, the one or more conditions may be based at least in part on a type of data to be transmitted on the sidelink (for example, throughout a duration of the sidelink). For example, the first UE 905 may be permitted to use mini-slot-based scheduling or the multiple available starting time domain locations for links dedicated to transmission of high priority data or data associated with small packet delay budgets (PDBs). In other examples, the first UE 905 may not be permitted to use mini-slot-based scheduling or the multiple available starting time domain locations for links dedicated to transmission of lower priority data or data associated with larger PDBs.

For example, the one or more conditions include a condition associated with a priority value that is associated with the sidelink communication or data to be transmitted via the sidelink. The priority value may be a ProSe per packet priority (PPPP), among other examples. The condition associated with the priority value may be satisfied based at least in part on the priority value satisfying a threshold. For example, if the priority value (for example, a PPPP value) of sidelink transmissions is less than a threshold (for example, because a lower priority value may indicate a higher priority transmission), then the first UE 905 may be permitted to use mini-slot-based scheduling or the multiple available starting time domain locations.

As another example, the one or more conditions may include a condition associated with a packet delay budget that is associated with the sidelink communication or data to be transmitted via the sidelink. In such examples, the condition may be satisfied based at least in part on the packet delay budget satisfying a threshold. For example, if the packet delay budget is less than the threshold, then the first UE 905 may be permitted to use mini-slot-based scheduling or the multiple available starting time domain locations (for example, the first UE 905 may use mini-slot-based scheduling or the multiple available starting time domain locations for latency sensitive or low-packet delay budget data). For example, conditions associated with the packet delay budget or the priority may assume that transmissions over the sidelink (for example, by the first UE 905 or other UEs) have fixed values (for example, fixed priorities or fixed packet delay budgets). If the packet delay budget or the priority of transmissions over the sidelink may change over time, then the first UE 905 may not use the conditions associated with the packet delay budget or the priority to determine whether to use the multiple available starting time domain locations or mini-slot-based scheduling.

As another example, the one or more conditions may include a condition associated with an application that is associated with a sidelink communication. For example, the first UE 905 may be configured with (for example, in the first operation 915) one or more (or a list) of applications to be associated with mini-slot-based scheduling or the multiple available starting time domain locations. For example, the condition may be associated with one or more applications for which the first UE 905 is permitted to use the multiple available starting time domain locations. The first UE 905 may determine that the condition is satisfied based at least in part on an application associated with a given sidelink communication being included in the one or more applications. In some aspects, the first UE 905 may apply the condition associated with an application that is associated with a sidelink communication (or all transmissions over the sidelink) where the packet delay budget or the priority or transmissions over the sidelink may change over time. In some aspects, if the sidelink is associated with multiple applications, then the first UE 905 may be permitted to use the multiple available starting time domain locations or mini-slot-based scheduling based at least in part on all applications (from the multiple applications) being included in the one or more (or the list) of applications to be associated with mini-slot-based scheduling or the multiple available starting time domain locations.

In some aspects, as described in more detail elsewhere herein, introducing mini-slot-based scheduling or the multiple available starting time domain locations may introduce an AGC issue for receiving UEs. Therefore, in some aspects, the one or more conditions may include conditions associated with the first UE 905 being more conservative when selecting a starting time domain location for a sidelink communication that does not align with a slot boundary.

For example, the one or more conditions may include a condition associated with the energy detection threshold of the channel access procedure. In such examples, the condition is satisfied based at least in part on the one or more measurements satisfying the energy detection threshold by an amount X. In other words, the condition may indicate that the energy detection threshold is a modified energy detection threshold (for example, when accessing or selecting a starting time domain location for a sidelink communication that does not align with a slot boundary) that is modified by the amount X from another energy detection threshold associated with the channel access procedure (for example, from the typical or configured energy detection threshold for the channel access procedure over a slot). In such examples, the first UE 905 may determine that the condition is satisfied based at least in part on one or more measurements associated with a channel access procedure satisfying the modified energy detection threshold. For example, if mini-slot-based scheduling is enabled for the first UE 905, then accessing the channel over an additional starting position (for example, not at a conventional full-slot boundary) may require a channel access procedure or an LBT to use an energy detection threshold that is X decibel-milliwatts (dBm) less than the (“normal”) energy detection threshold used for access over conventional full-slot boundaries, in order to determine that the channel is idle.

In some aspects, a value associated with the amount X may be stored by the first UE 905 or indicated in a configuration received by the first UE 905 (for example, in the first operation 915). Additionally or alternatively, the first UE 905 may select a value associated with the amount X from a range of values or a list of values. In some aspects, the condition associated with the energy detection threshold may be applicable based at least in part on one or more other conditions, from the one or more conditions, being satisfied. For example, the one or more other conditions may include a first condition associated with a channel busy ratio (for example, a conventional channel busy ratio, or the modified channel busy ratio described elsewhere herein) of the sidelink channel (for example, the first condition may be satisfied if the channel busy ratio satisfies a first threshold), a second condition associated with an average duty cycle associated with a sidelink (for example, the second condition may be satisfied if the average duty cycle satisfies a second threshold), or a third condition associated with a bandwidth occupancy of the sidelink (for example, the third condition may be satisfied if the bandwidth occupancy (a bandwidth occupancy rate) satisfies a third threshold), among other examples.

In some aspects, the one or more conditions may include dynamic conditions that are based at least in part on conditions associated with a given sidelink communication (for example, transmitted by the first UE 905 in a sixth operation 940 described below). For example, the one or more conditions may include a condition associated with a reservation status of a slot in which the sidelink communication is to be transmitted. In such examples, the condition may be satisfied based at least in part on the reservation status indicating that no other UEs have reserved resources associated with the slot in which the starting time domain location of a sidelink communication is included. This may ensure that a receiving UE will not receive another sidelink communication in the slot, thereby reducing a likelihood of the receiving UE experiencing an AGC issue, as described elsewhere herein.

As another example, the one or more conditions may include a condition associated with a bandwidth size of the sidelink communication. In such examples, the condition may be satisfied based at least in part on the bandwidth size of the sidelink communication occupying a full bandwidth size associated with the sidelink channel. This may ensure that a receiving UE will not receive another sidelink communication at a time that overlaps with the sidelink communication because there may not be available bandwidth for another communication (for example, because the sidelink communication is occupying the full bandwidth size), thereby reducing a likelihood of the receiving UE experiencing an AGC issue, as described elsewhere herein.

As another example, the one or more conditions may include a condition associated with a shared channel occupancy time associated with the sidelink channel. In such examples, the first UE 905 may determine that the condition is satisfied based at least in part on a starting time domain location of a sidelink communication occurring outside of the shared channel occupancy time. In other words, transmissions that occur during an active or ongoing channel occupancy time may only occur over full-slot boundaries (for example, may be restricted to slot-based scheduling). For example, a channel occupancy time may be a time reserved for communications of a given RAT over the shared or unlicensed frequency band. For example, during the channel occupancy time, devices associated with other RATs may not be permitted to transmit on the shared or unlicensed frequency band. Therefore, during a channel occupancy time (for example, a channel occupancy time associated with the first UE 905 or shared among multiple UEs including the first UE 905), the first UE 905 may not be permitted to use the multiple available starting time domain locations or mini-slot-based scheduling because the channel occupancy time may ensure that there is no activity of other RATs on the shared or unlicensed frequency band (for example, thereby reducing a need for the use of the multiple available starting time domain locations or mini-slot-based scheduling). A sidelink transmission that is initiated outside of a shared channel occupancy time associated with the sidelink channel may be permitted to use the multiple available starting time domain locations or mini-slot-based scheduling because there may be activity on the shared or unlicensed frequency band associated with other devices (for example, that use different RATs).

In some aspects, the one or more conditions may include a condition associated with a subcarrier spacing associated with a sidelink communication or a resource pool configured for the first UE 905. In such examples, the first UE 905 may determine that the condition is satisfied based at least in part on the subcarrier spacing satisfying a threshold. For example, communications associated with high subcarrier spacings may have a reduced benefit from the use of the multiple available starting time domain locations or mini-slot-based scheduling due to the shorter slot durations associated with the high subcarrier spacings. The first UE 905 may be configured (for example, in the first operation 915) with one or more resource pools. Each resource pool may be associated with a subcarrier spacing. For sidelink operations over resource pools associated with a subcarrier spacing from a set of one or more subcarrier spacings, the first UE 905 may not be permitted to use the multiple available starting time domain locations or mini-slot-based scheduling. For example, the configuration information (for example, received by the first UE 905 in the first operation 915) may indicate one or more subcarrier spacings for which the first UE 905 is permitted to use the multiple available starting time domain locations or mini-slot-based scheduling, or may indicate one or more subcarrier spacings for which the first UE 905 is not permitted to use the multiple available starting time domain locations or mini-slot-based scheduling. For example, the first UE 905 may not be permitted to use the multiple available starting time domain locations or mini-slot-based scheduling for sidelink communications associated with a subcarrier spacing that is greater than or equal to 60 KHz.

In a third operation 925, the first UE 905 or the second UE 910 may operate using mini-slot-based scheduling or slot-based scheduling based at least in part on whether the one or more conditions are satisfied (for example, one or more, or all, of the conditions described herein). In some aspects, each UE (for example, the first UE 905 and the second UE 910) may individually determine whether the one or more conditions are satisfied.

Additionally or alternatively, in a fourth operation 930, the first UE 905 may transmit, and the second UE 910 may receive, an indication to use slot-based scheduling or mini-slot-based scheduling. For example, the first UE 905 may determine whether the one or more conditions are satisfied (for example, as described in more detail elsewhere herein). If the first UE 905 determines that the one or more conditions are satisfied, then the first UE 905 may transmit, and the second UE 910 may receive, an indication to use mini-slot-based scheduling (for example, which may cause the second UE 910 to monitor for SCI in resource pools associated with the mini-slot-based scheduling). If the first UE 905 determines that the one or more conditions are not satisfied, then the first UE 905 may transmit, and the second UE 910 may receive, an indication to use slot-based scheduling (for example, which may cause the second UE 910 to monitor for SCI in resource pools associated with the slot-based scheduling and refrain from monitoring for SCI in resource pools associated with the mini-slot-based scheduling). The indication transmitted by the first UE 905 in the fourth operation 930 may be a Layer 3 (L3) signal or a Layer 1 (L1) signal. For example, as part of the fourth operation 930, the first UE 905 may transmit a sidelink RRC communication indicating whether to use slot-based scheduling or mini-slot-based scheduling. As another example, as part of the fourth operation 930, the first UE 905 may transmit a sidelink MAC-CE communication indicating whether to use slot-based scheduling or mini-slot-based scheduling. As another example, as part of the fourth operation 930, the first UE 905 may transmit an SCI communication indicating whether to use slot-based scheduling or mini-slot-based scheduling.

In a fifth operation 935, the first UE 905 may perform one or more measurements associated with a channel access procedure for accessing the shared or unlicensed sidelink channel (for example, the shared or unlicensed frequency band). For example, the channel access procedure may be an LBT procedure. In a sixth operation 940, the first UE 905 may transmit, and the second UE 910 (or one or more other UEs) may receive, a sidelink communication based at least in part on the one or more measurements satisfying an energy detection threshold associated with the channel access procedure. For example, if the one or more measurements satisfy the energy detection threshold, then the first UE 905 may determine that the shared or unlicensed sidelink channel (for example, the shared or unlicensed frequency band) is idle. If the one or more measurements do not satisfy the energy detection threshold, then the first UE 905 may determine that the shared or unlicensed sidelink channel (for example, the shared or unlicensed frequency band) is busy (for example, the channel access procedure may be associated with a failure) and the first UE 905 may refrain from performing the sixth operation 940.

Based at least in part on determining that the shared or unlicensed sidelink channel is idle, the first UE 905 may determine a starting time domain location for the sidelink communication. For example, if the first UE 905 determines that the one or more conditions (for example, described elsewhere herein) are satisfied, then the first UE 905 may determine the starting time domain location for the sidelink communication from configured slot boundaries and from multiple available starting time domain locations that include one or more starting time domain locations that are not aligned with a slot boundary (for example, the first UE 905 may use mini-slot-based scheduling). If the first UE 905 determines that the one or more conditions (for example, described elsewhere herein) are not satisfied, then the first UE 905 may determine the starting time domain location for the sidelink communication only from configured slot boundaries (for example, and not from the multiple available starting time domain locations that may not be aligned with slot boundaries). For example, the first UE 905 may transmit (for example, as part of the sixth operation 940) the sidelink communication at a starting time domain location (for example, an earliest OFDM symbol associated with the sidelink location) that is aligned with a slot boundary based at least in part on one or more conditions not being satisfied. Alternatively, the first UE 905 may transmit (for example, as part of the sixth operation 940) the sidelink communication at a starting time domain location (for example, an earliest OFDM symbol associated with the sidelink location) that is included in multiple available starting time domain locations that include one or more starting time domain locations that are not aligned with any slot boundary based at least in part on the one or more conditions being satisfied. In other words, if the first UE 905 determines that the one or more conditions are satisfied, then the first UE 905 may transmit the sidelink communication at a starting time domain location that aligns with a slot boundary or that does not align with a slot boundary. However, if the first UE 905 determines that the one or more conditions are not satisfied, then the first UE 905 may only transmit the sidelink communication at a starting time domain location that align with a slot boundary.

In this way, a mini-slot-based scheduling feature may be conditionally or optionally enabled for UEs based at least in part on the one or more conditions. In some examples, the described techniques can be used to improve a likelihood that a first UE 905 is able to access the shared or unlicensed sidelink channel by increasing a quantity of starting time domain locations available for sidelink communications, thereby reducing a delay between a time at which the first UE 905 detects that the shared or unlicensed sidelink channel is idle (for example, in the fifth operation 935) and a next available starting time domain location. Additionally, by limiting the use of the multiple available starting time domain locations or mini-slot-based scheduling to certain scenarios (for example, when the one or more conditions are satisfied), a decoding complexity or power consumption associated with using the multiple available starting time domain locations or mini-slot-based scheduling may not be needlessly increased. Further, the first UE 905 transmitting sidelink communications using the multiple available starting time domain locations or mini-slot-based scheduling only when the one or more conditions are satisfied may reduce a likelihood of a receiving UE experiencing an AGC issue (for example, using an inappropriate power gain value, as explained in more detail elsewhere herein).

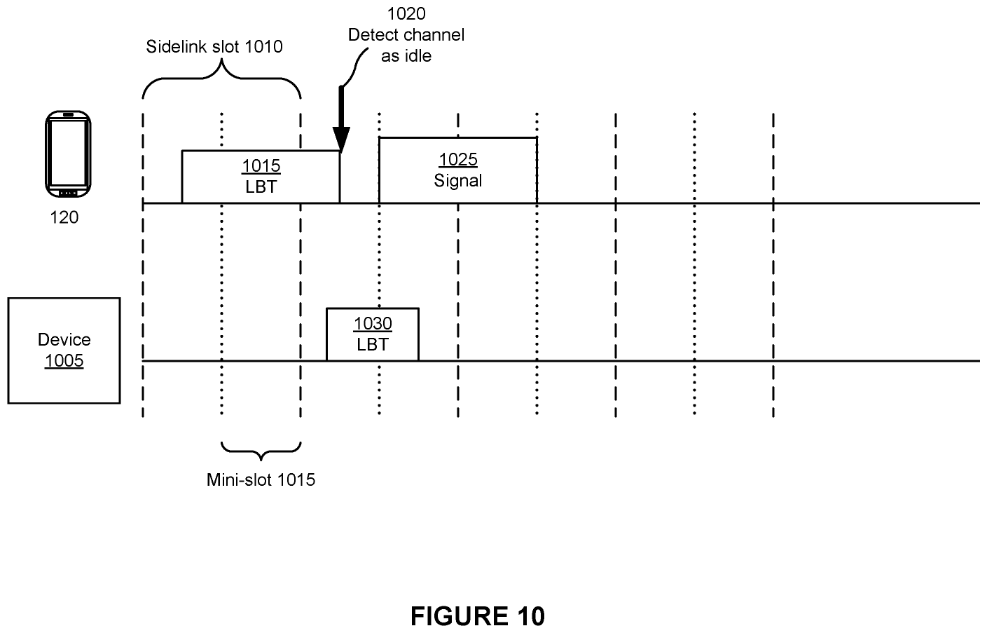

FIG. 10 is a diagram of an example associated with conditional transmissions using additional starting positions for sidelink communications in accordance with the present disclosure. As shown in FIG. 10, a UE 120 (for example, the first UE 905) UE 120 may communicate in a shared or unlicensed frequency band. For example, the UE 120 may communicate one or more sidelink signals in a shared or unlicensed frequency band. As shown in FIG. 10, the UE 120 may be configured with one or more sidelink slots 1010 and one or more mini-slots 1015. For example, the UE 120 may use mini-slot-based scheduling to transmit or receive the one or more sidelink signals. In other words, the UE 120 may transmit signals starting at a start of a sidelink slot 1010 or at a start of a mini-slot 1015.

One or more other devices, such as a device 1005, may operate in the shared or unlicensed frequency band. The device 1005 may be associated with a different RAT (for example, different than a RAT used by the UE 120), a different slot format, a different transmission timing, or a different scheduling technique, among other examples (for example, as compared to the UE 120). For example, the device 1005 may be associated with an asynchronous transmission timing (for example, the device may not have to wait for scheduling to transmit signals).

In a first operation 1015, the UE 120 may perform a channel access procedure, such as an LBT procedure (for example, in a similar manner as described in more detail elsewhere herein). In a second operation 1020, the UE 120 may detect that the channel (for example, the shared or unlicensed frequency band) is idle (for example, based at least in part on the channel access procedure being successful). However, a timing of the UE 120 detecting that the channel is idle may occur in a middle of a sidelink slot 1010. In other words, a timing of the UE 120 detecting that the channel (for example, the shared or unlicensed frequency band) is idle may be arbitrary (for example, may occur at any time). However, in a third operation 1025, the UE 120 may transmit a sidelink signal starting at a start of a mini-slot. For example, as shown in FIG. 10, the UE 120 may not be required to wait until a start of a next slot (for example, after detecting that the channel is idle in the second operation 1020) to transmit the sidelink signal in the third operation 1025.

This may reduce a likelihood that the device 1005 is able to sense the channel (for example, the shared or unlicensed frequency band) and initiate a transmission before the next transmission opportunity for the UE 120. For example, in a fourth operation 1030, the device 1005 may perform a channel access procedure. However, because of the transmission of the sidelink signal by the UE 120 in the third operation 1025, the device 1005 may detect that the channel is busy and may refrain from transmitting on the channel.

Therefore, the UE 120 using mini-slot-based scheduling may improve a likelihood that the UE 120 is able to transmit the sidelink signal or may reduce a latency associated with the sidelink signal. However, as described in more detail elsewhere herein, the UE 120 using mini-slot-based scheduling may increase a power consumption or decoding complexity. For example, a receiving UE may be required to monitor for or receive SCI at least once in each mini-slot (for example, as compared to at least once in each slot for slot-based scheduling). Therefore, an overhead associated with monitoring for or receiving the SCI may be increased when mini-slot-based scheduling is used because the mini-slots may occur more frequently in time than the slots. Therefore, the UE 120 may conditionally use mini-slot-based scheduling as shown in FIG. 10 (for example, subject to one or more conditions being satisfied, as described in more detail elsewhere herein, such as in connection with FIG. 9).

FIG. 11 is a flowchart illustrating an example process 1100 performed, for example, by a UE that supports conditional transmissions using additional starting positions for unlicensed sidelink communications in accordance with the present disclosure. Example process 1100 is an example where the UE (for example, UE 120) performs operations associated with conditional transmissions using additional starting positions for unlicensed sidelink communications.

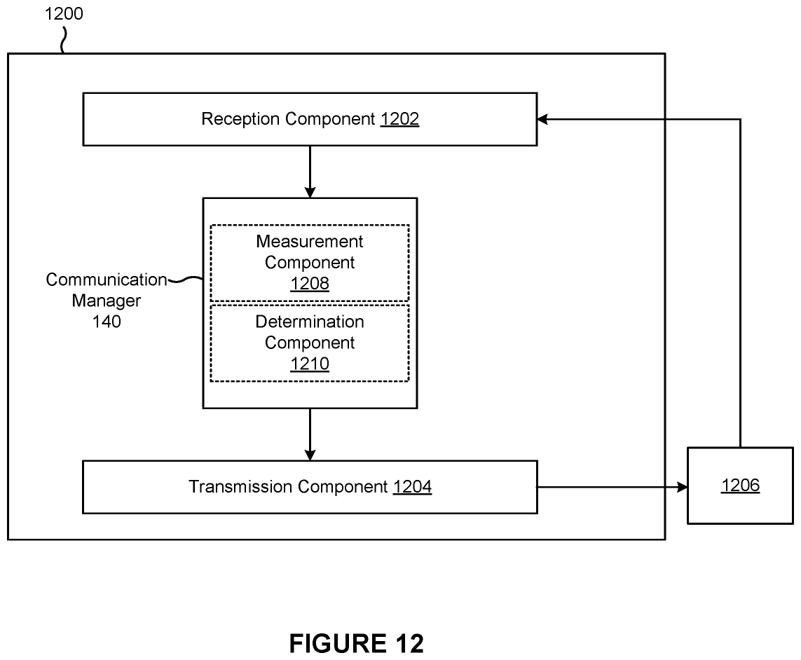

As shown in FIG. 11, in some aspects, process 1100 may include performing one or more measurements associated with a channel access procedure for accessing a shared or unlicensed sidelink channel (block 1110). For example, the UE (such as by using communication manager 140 or measurement component 1208, depicted in FIG. 12) may perform one or more measurements associated with a channel access procedure for accessing a shared or unlicensed sidelink channel, as described above.

As further shown in FIG. 11, in some aspects, process 1100 may include transmitting, based at least in part on the one or more measurements satisfying an energy detection threshold, a sidelink communication at a starting time domain location that is aligned with a boundary of a slot based at least in part on one or more conditions not being satisfied, or that is one of multiple available starting time domain locations of the slot based at least in part on the one or more conditions being satisfied, the multiple available starting time domain locations of the slot including one or more starting time domain locations that are not aligned with any slot boundary (block 1120). For example, the UE (such as by using communication manager 140 or transmission component 1204, depicted in FIG. 12) may transmit, based at least in part on the one or more measurements satisfying an energy detection threshold, a sidelink communication at a starting time domain location that is aligned with a boundary of a slot based at least in part on one or more conditions not being satisfied, or that is one of multiple available starting time domain locations of the slot based at least in part on the one or more conditions being satisfied, the multiple available starting time domain locations of the slot including one or more starting time domain locations that are not aligned with any slot boundary, as described above.

Process 1100 may include additional aspects, such as any single aspect or any combination of aspects described below or in connection with one or more other processes described elsewhere herein.

In a first additional aspect, the multiple available starting time domain locations are aligned with respective mini-slot boundaries within one or more slots.

In a second additional aspect, alone or in combination with the first aspect, the one or more conditions include a condition associated with a cast type of the sidelink communication.

In a third additional aspect, alone or in combination with one or more of the first and second aspects, the condition indicates one or more cast types for which the UE is not permitted to use the multiple available starting time domain locations, and the condition is not satisfied based at least in part on the cast type of the sidelink communication being included in the one or more cast types.

In a fourth additional aspect, alone or in combination with one or more of the first through third aspects, the condition indicates one or more cast types for which the UE is permitted to use the multiple available starting time domain locations, and the condition is satisfied based at least in part on the cast type of the sidelink communication is included in the one or more cast types.

In a fifth additional aspect, alone or in combination with one or more of the first through fourth aspects, the one or more cast types for which the UE is permitted to use the multiple available starting time domain locations are indicated in a configuration received by the UE or stored by the UE.

In a sixth additional aspect, alone or in combination with one or more of the first through fifth aspects, the one or more conditions include a condition associated with a failure rate of the channel access procedure, where the condition is satisfied based at least in part on the failure rate satisfying a rate threshold.

In a seventh additional aspect, alone or in combination with one or more of the first through sixth aspects, the UE is communicating using a first RAT, where the one or more conditions include a condition associated with a channel busy ratio (CBR) that is associated with one or more RATs other than the first RAT, and where the condition is satisfied based at least in part on the CBR satisfying a CBR threshold.

In an eighth additional aspect, alone or in combination with one or more of the first through seventh aspects, process 1100 includes measuring the channel busy ratio.

In a ninth additional aspect, alone or in combination with one or more of the first through eighth aspects, the CBR threshold is a first threshold, where the condition is satisfied based at least in part the condition being satisfied for a quantity of UEs, including the UE, associated with a sidelink associated with the sidelink communication, where the quantity satisfies a second threshold.

In a tenth additional aspect, alone or in combination with one or more of the first through ninth aspects, the UEs are transmitting UEs associated with the sidelink.

In an eleventh additional aspect, alone or in combination with one or more of the first through tenth aspects, the UEs are receiving UEs associated with the sidelink.

In a twelfth additional aspect, alone or in combination with one or more of the first through eleventh aspects, the one or more conditions include a condition associated with a priority value that is associated with the sidelink communication, where the condition is satisfied based at least in part on the priority value satisfying a priority value threshold.

In a thirteenth additional aspect, alone or in combination with one or more of the first through twelfth aspects, the one or more conditions include a condition associated with a packet delay budget (PDB) that is associated with the sidelink communication, where the condition is satisfied based at least in part on the PDB satisfying a PDB threshold.

In a fourteenth additional aspect, alone or in combination with one or more of the first through thirteenth aspects, the one or more conditions include a condition associated with an application that is associated with the sidelink communication, where the condition indicates one or more applications for which the UE is permitted to use the multiple available starting time domain locations, and where the condition is satisfied based at least in part on the application being included in the one or more applications.

In a fifteenth additional aspect, alone or in combination with one or more of the first through fourteenth aspects, the starting time domain location is included in the one or more starting time domain locations that are not aligned with any slot boundary, where the one or more conditions include a condition associated with the energy detection threshold, where the condition indicates that the energy detection threshold is a modified energy detection threshold that is modified by an amount from another energy detection threshold associated with the channel access procedure, and where the condition is satisfied based at least in part on the one or more measurements satisfying the modified energy detection threshold.

In a sixteenth additional aspect, alone or in combination with one or more of the first through fifteenth aspects, a value associated with the amount is stored by the UE or indicated in a configuration received by the UE.

In a seventeenth additional aspect, alone or in combination with one or more of the first through sixteenth aspects, process 100 includes selecting a value associated with the amount from a range of values or a list of values.

In an eighteenth additional aspect, alone or in combination with one or more of the first through seventeenth aspects, the condition associated with the energy detection threshold is applicable based at least in part on one or more other conditions, from the one or more conditions, being satisfied.

In a nineteenth additional aspect, alone or in combination with one or more of the first through eighteenth aspects, the one or more other conditions include at least one of a first condition associated with a channel busy ratio of the sidelink channel, a second condition associated with an average duty cycle associated with a sidelink that is associated with the sidelink communication, or a third condition associated with a bandwidth occupancy of the sidelink.

In a twentieth additional aspect, alone or in combination with one or more of the first through nineteenth aspects, the one or more conditions include a condition associated with a reservation status of the slot in which the sidelink communication is to be transmitted, and the condition is satisfied based at least in part on the reservation status indicating that no other UEs have reserved resources associated with the slot.

In a twenty-first additional aspect, alone or in combination with one or more of the first through twentieth aspects, the one or more conditions include a condition associated with a bandwidth size of the transmission of the sidelink communication, and the condition is satisfied based at least in part on the bandwidth size occupying a full bandwidth size associated with the sidelink channel.

In a twenty-second additional aspect, alone or in combination with one or more of the first through twenty-first aspects, the one or more conditions include a condition associated with a shared channel occupancy time associated with the sidelink channel, and the condition is satisfied based at least in part on the starting time domain location occurring outside of the shared channel occupancy time.

In a twenty-third additional aspect, alone or in combination with one or more of the first through twenty-second aspects, the one or more conditions include a condition associated with an subcarrier spacing (SCS) of the transmission of the sidelink communication, and the condition is satisfied based at least in part on the SCS satisfying an SCS threshold.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication that supports conditional transmissions using additional starting positions for unlicensed sidelink communications in accordance with the present disclosure. The apparatus 1200 may be a UE, or a UE may include the apparatus 1200. In some aspects, the apparatus 1200 includes a reception component 1202, a transmission component 1204, and a communication manager 140, which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to perform one or more operations described herein in connection with FIGS. 9-10. Additionally or alternatively, the apparatus 1200 may be configured to perform one or more processes described herein, such as process 1100 of FIG. 11, or a combination thereof. In some aspects, the apparatus 1200 may include one or more components of the UE described above in connection with FIG. 2.

The reception component 1202 may receive communications, such as reference signals, control information, data communications, or a combination thereof, from the apparatus 1206. The reception component 1202 may provide received communications to one or more other components of the apparatus 1200, such as the communication manager 140. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, a modem, a demodulator, a MIMO detector, a receive processor, a controller/processor, a memory, or a combination thereof, of the UE described above in connection with FIG. 2.

The transmission component 1204 may transmit communications, such as reference signals, control information, data communications, or a combination thereof, to the apparatus 1206. In some aspects, the communication manager 140 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described above in connection with FIG. 2. In some aspects, the transmission component 1204 may be co-located with the reception component 1202 in a transceiver.

The communication manager 140 may perform one or more measurements associated with a channel access procedure for accessing a shared or unlicensed sidelink channel. The communication manager 140 may transmit or may cause the transmission component 1204 to transmit, based at least in part on the one or more measurements satisfying an energy detection threshold, a sidelink communication at a starting time domain location that is aligned with a boundary of a slot based at least in part on one or more conditions not being satisfied, or that is one of multiple available starting time domain locations of the slot based at least in part on the one or more conditions being satisfied, the multiple available starting time domain locations of the slot including one or more starting time domain locations that are not aligned with any slot boundary. In some aspects, the communication manager 140 may perform one or more operations described elsewhere herein as being performed by one or more components of the communication manager 140.

The communication manager 140 may include a controller/processor, a memory, or a combination thereof, of the UE described above in connection with FIG. 2. In some aspects, the communication manager 140 includes a set of components, such as a measurement component 1208, a determination component 1210, or a combination thereof. Alternatively, the set of components may be separate and distinct from the communication manager 140. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The measurement component 1208 may perform one or more measurements associated with a channel access procedure for accessing a shared or unlicensed sidelink channel. The transmission component 1204 may transmit, based at least in part on the one or more measurements satisfying an energy detection threshold, a sidelink communication at a starting time domain location aligned with a slot boundary based at least in part on one or more conditions not being satisfied, or included in multiple available starting time domain locations that include one or more starting time domain locations that are not aligned with any slot boundary based at least in part on the one or more conditions being satisfied.

The determination component 1210 may determine whether the one or more conditions are satisfied.

The measurement component 1208 may measure a channel busy ratio associated with the one or more conditions.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

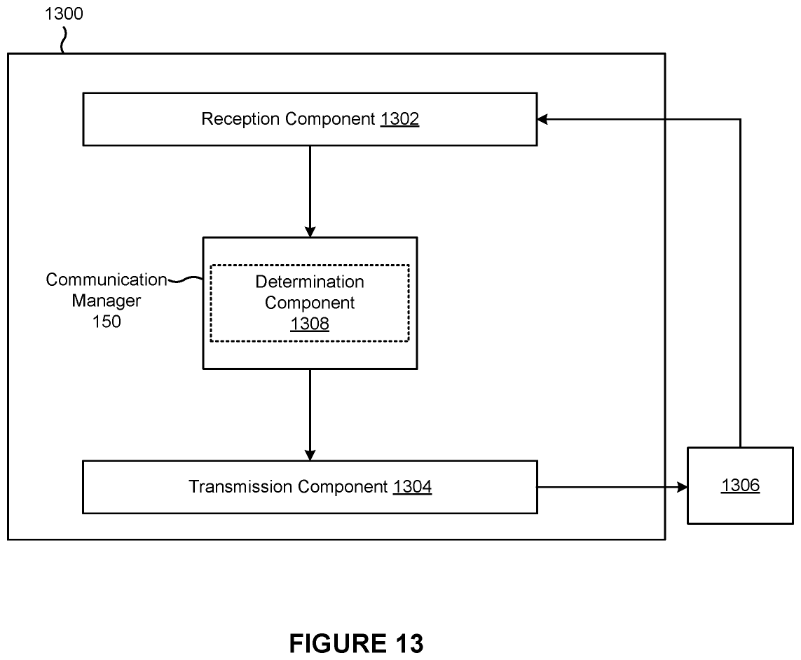

FIG. 13 is a diagram of an example apparatus 1300 for wireless communication that supports conditional transmissions using additional starting positions for unlicensed sidelink communications in accordance with the present disclosure. The apparatus 1300 may be a network node, or a network node may include the apparatus 1300. In some aspects, the apparatus 1300 includes a reception component 1302, a transmission component 1304, and a communication manager 150, which may be in communication with one another (for example, via one or more buses). As shown, the apparatus 1300 may communicate with another apparatus 1306 (such as a UE, a network node, or another wireless communication device) using the reception component 1302 and the transmission component 1304.

In some aspects, the apparatus 1300 may be configured to perform one or more operations described herein in connection with FIGS. 9-10. Additionally or alternatively, the apparatus 1300 may be configured to perform one or more processes described herein, or a combination thereof. In some aspects, the apparatus 1300 may include one or more components of the network node described above in connection with FIG. 2.

The reception component 1302 may receive communications, such as reference signals, control information, data communications, or a combination thereof, from the apparatus 1306. The reception component 1302 may provide received communications to one or more other components of the apparatus 1300, such as the communication manager 150. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, a modem, a demodulator, a MIMO detector, a receive processor, a controller/processor, a memory, or a combination thereof, of the network node described above in connection with FIG. 2.

The transmission component 1304 may transmit communications, such as reference signals, control information, data communications, or a combination thereof, to the apparatus 1306. In some aspects, the communication manager 150 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described above in connection with FIG. 2. In some aspects, the transmission component 1304 may be co-located with the reception component 1302 in a transceiver.

The communication manager 150 may transmit or may cause the transmission component 1304 to transmit configuration information, intended for a UE, that indicates one or more conditions associated with a usage of multiple available starting time domain locations or mini-slot-based scheduling in a shared or unlicensed frequency band. In some aspects, the communication manager 150 may perform one or more operations described elsewhere herein as being performed by one or more components of the communication manager 150.

The communication manager 150 may include a controller/processor, a memory, a scheduler, a communication unit, or a combination thereof, of the network node described above in connection with FIG. 2. In some aspects, the communication manager 150 includes a set of components, such as a determination component 1308, or a combination thereof. Alternatively, the set of components may be separate and distinct from the communication manager 150. In some aspects, one or more components of the set of components may include or may be implemented within a controller/processor, a memory, a scheduler, a communication unit, or a combination thereof, of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1304 may transmit configuration information, intended for a UE, that indicates one or more conditions associated with a usage of multiple available starting time domain locations or mini-slot-based scheduling in a shared or unlicensed frequency band. The determination component 1308 may determine the one or more conditions.

The quantity and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: performing one or more measurements associated with a channel access procedure for accessing a shared or unlicensed sidelink channel; and transmitting, based at least in part on the one or more measurements satisfying an energy detection threshold, a sidelink communication at a starting time domain location that is aligned with a boundary of a slot based at least in part on one or more conditions not being satisfied, or that is one of multiple available starting time domain locations of the slot based at least in part on the one or more conditions being satisfied, the multiple available starting time domain locations of the slot including one or more starting time domain locations that are not aligned with any slot boundary.

Aspect 2: The method of Aspect 1, wherein the multiple available starting time domain locations are aligned with respective mini-slot boundaries within one or more slots.

Aspect 3: The method of any of Aspects 1-2, wherein the one or more conditions include a condition associated with a cast type of the sidelink communication.

Aspect 4: The method of Aspect 3, wherein the condition indicates one or more cast types for which the UE is not permitted to use the multiple available starting time domain locations, and wherein the condition is not satisfied based at least in part on the cast type of the sidelink communication being included in the one or more cast types.

Aspect 5: The method of any of Aspects 3-4, wherein the condition indicates one or more cast types for which the UE is permitted to use the multiple available starting time domain locations, and wherein the condition is satisfied based at least in part on the cast type of the sidelink communication is included in the one or more cast types.

Aspect 6: The method of Aspect 5, wherein the one or more cast types for which the UE is permitted to use the multiple available starting time domain locations are indicated in a configuration received by the UE or stored by the UE.

Aspect 7: The method of any of Aspects 1-6, wherein the one or more conditions include a condition associated with a failure rate of the channel access procedure, wherein the condition is satisfied based at least in part on the failure rate satisfying a rate threshold.

Aspect 8: The method of any of Aspects 1-7, wherein the UE is communicating using a first radio access technology (RAT), wherein the one or more conditions include a condition associated with a channel busy ratio (CBR) that is associated with one or more RATs other than the first RAT, and wherein the condition is satisfied based at least in part on the channel busy ratio satisfying a CBR threshold.

Aspect 9: The method of Aspect 8, further comprising measuring the CBR.

Aspect 10: The method of any of Aspects 8-9, wherein the CBR threshold is a first threshold, wherein the condition is satisfied based at least in part the condition being satisfied for a quantity of UEs, including the UE, associated with a sidelink associated with the sidelink communication, wherein the quantity satisfies a second threshold.

Aspect 11: The method of Aspect 10, wherein the UEs are transmitting UEs associated with the sidelink.

Aspect 12: The method of any of Aspects 10-11, wherein the UEs are receiving UEs associated with the sidelink.

Aspect 13: The method of any of Aspects 1-12, wherein the one or more conditions include a condition associated with a priority value that is associated with the sidelink communication, wherein the condition is satisfied based at least in part on the priority value satisfying a priority value threshold.

Aspect 14: The method of any of Aspects 1-13, wherein the one or more conditions include a condition associated with a packet delay budget (PDB) that is associated with the sidelink communication, wherein the condition is satisfied based at least in part on the packet delay budget satisfying a PDB threshold.

Aspect 15: The method of any of Aspects 1-14, wherein the one or more conditions include a condition associated with an application that is associated with the sidelink communication, wherein the condition indicates one or more applications for which the UE is permitted to use the multiple available starting time domain locations, and wherein the condition is satisfied based at least in part on the application being included in the one or more applications.

Aspect 16: The method of any of Aspects 1-15, wherein the starting time domain location is included in the one or more starting time domain locations that are not aligned with any slot boundary, wherein the one or more conditions include a condition associated with the energy detection threshold, wherein the condition indicates that the energy detection threshold is a modified energy detection threshold that is modified by an amount from another energy detection threshold associated with the channel access procedure, and wherein the condition is satisfied based at least in part on the one or more measurements satisfying the modified energy detection threshold.

Aspect 17: The method of Aspect 16, wherein a value associated with the amount is stored by the UE or indicated in a configuration received by the UE.

Aspect 18: The method of any of Aspects 16-17, further comprising selecting a value associated with the amount from a range of values or a list of values.

Aspect 19: The method of any of Aspects 16-18, wherein the condition associated with the energy detection threshold is applicable based at least in part on one or more other conditions, from the one or more conditions, being satisfied.

Aspect 20: The method of Aspect 19, wherein the one or more other conditions include at least one of: a first condition associated with a channel busy ratio of the sidelink channel, a second condition associated with an average duty cycle associated with a sidelink that is associated with the sidelink communication, or a third condition associated with a bandwidth occupancy of the sidelink.

Aspect 21: The method of any of Aspects 1-20, wherein the one or more conditions include a condition associated with a reservation status of the slot in which the sidelink communication is to be transmitted, and wherein the condition is satisfied based at least in part on the reservation status indicating that no other UEs have reserved resources associated with the slot.

Aspect 22: The method of any of Aspects 1-21, wherein the one or more conditions include a condition associated with a bandwidth size of the transmission of the sidelink communication, and wherein the condition is satisfied based at least in part on the bandwidth size occupying a full bandwidth size associated with the sidelink channel.

Aspect 23: The method of any of Aspects 1-22, wherein the one or more conditions include a condition associated with a shared channel occupancy time associated with the sidelink channel, and wherein the condition is satisfied based at least in part on the starting time domain location occurring outside of the shared channel occupancy time.

Aspect 24: The method of any of Aspects 1-23, wherein the one or more conditions include a condition associated with a subcarrier spacing (SCS) of the transmission of the sidelink communication, and wherein the condition is satisfied based at least in part on the SCS satisfying an SCS threshold.

Aspect 25: An apparatus for wireless communication at a device, comprising a processor; memory coupled with the processor; and instructions stored in the memory and executable by the processor to cause the apparatus to perform the method of one or more of Aspects 1-24.

Aspect 26: A device for wireless communication, comprising a memory and one or more processors coupled to the memory, the one or more processors configured to perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one memory; and
at least one processor communicatively coupled with the at least one memory, the at least one processor configured to cause the UE to:
perform one or more measurements associated with a channel access procedure for accessing a shared or unlicensed sidelink channel; and
transmit, based at least in part on the one or more measurements satisfying an energy detection threshold, a sidelink communication at a starting time domain location that is aligned with a boundary of a slot based at least in part on one or more conditions not being satisfied, or that is one of multiple available starting time domain locations of the slot based at least in part on the one or more conditions being satisfied, the multiple available starting time domain locations of the slot including one or more starting time domain locations that are not aligned with any slot boundary.

2. The UE of claim 1, wherein the one or more conditions include a condition associated with a cast type of the sidelink communication.

3. The UE of claim 2, wherein the condition indicates one or more cast types for which the UE is not permitted to use the multiple available starting time domain locations, and wherein the condition is not satisfied based at least in part on the cast type of the sidelink communication being included in the one or more cast types.

4. The UE of claim 2, wherein the condition indicates one or more cast types for which the UE is permitted to use the multiple available starting time domain locations, and wherein the condition is satisfied based at least in part on the cast type of the sidelink communication is included in the one or more cast types.

5. The UE of claim 4, wherein the one or more cast types for which the UE is permitted to use the multiple available starting time domain locations are indicated in a configuration received by the UE or stored by the UE.

6. The UE of claim 1, wherein the one or more conditions include a condition associated with a failure rate of the channel access procedure, wherein the condition is satisfied based at least in part on the failure rate satisfying a rate threshold.

7. The UE of claim 1, wherein the one or more conditions include a condition associated with a priority value that is associated with the sidelink communication, wherein the condition is satisfied based at least in part on the priority value satisfying a priority value threshold.

8. The UE of claim 1, wherein the one or more conditions include a condition associated with a packet delay budget that is associated with the sidelink communication, wherein the condition is satisfied based at least in part on the packet delay budget (PDB) satisfying a PDB threshold. 9 The UE of claim 1, wherein the starting time domain location is included in the one or more starting time domain locations that are not aligned with any slot boundary, wherein the one or more conditions include a condition associated with the energy detection threshold, wherein the condition indicates that the energy detection threshold is a modified energy detection threshold that is modified by an amount from another energy detection threshold associated with the channel access procedure, and wherein the condition is satisfied based at least in part on the one or more measurements satisfying the modified energy detection threshold.

10. The UE of claim 9, wherein at least one processor is further configured to cause the UE to select a value associated with the amount from a range of values or a list of values.

11. The UE of claim 9, wherein the condition associated with the energy detection threshold is applicable based at least in part on one or more other conditions, from the one or more conditions, being satisfied, wherein the one or more other conditions include at least one of:
a first condition associated with a channel busy ratio of the sidelink channel,
a second condition associated with an average duty cycle associated with a sidelink that is associated with the sidelink communication, or
a third condition associated with a bandwidth occupancy of the sidelink.

12. The UE of claim 1, wherein the one or more conditions include a condition associated with a reservation status of the slot in which the sidelink communication is to be transmitted, and wherein the condition is satisfied based at least in part on the reservation status indicating that no other UEs have reserved resources associated with the slot.

13. The UE of claim 1, wherein the one or more conditions include a condition associated with a bandwidth size of the transmission of the sidelink communication, and wherein the condition is satisfied based at least in part on the bandwidth size occupying a full bandwidth size associated with the sidelink channel.

14. The UE of claim 1, wherein the one or more conditions include a condition associated with a shared channel occupancy time associated with the sidelink channel, and wherein the condition is satisfied based at least in part on the starting time domain location occurring outside of the shared channel occupancy time.

15. The UE of claim 1, wherein the one or more conditions include a condition associated with a subcarrier spacing (SCS) for the transmission of the sidelink communication, and wherein the condition is satisfied based at least in part on the subcarrier spacing satisfying an SCS threshold.

16. A method of wireless communication performed by a user equipment (UE), comprising:
performing one or more measurements associated with a channel access procedure for accessing a shared or unlicensed sidelink channel; and
transmitting, based at least in part on the one or more measurements satisfying an energy detection threshold, a sidelink communication at a starting time domain location that is aligned with a boundary of a slot based at least in part on one or more conditions not being satisfied, or that is one of multiple available starting time domain locations of the slot based at least in part on the one or more conditions being satisfied, the multiple available starting time domain locations of the slot including one or more starting time domain locations that are not aligned with any slot boundary.

17. The method of claim 16, wherein the multiple available starting time domain locations are aligned with respective mini-slot boundaries within one or more slots.

18. The method of claim 16, wherein the one or more conditions include a condition associated with a cast type of the sidelink communication.

19. The method of claim 18, wherein the condition indicates one or more cast types for which the UE is not permitted to use the multiple available starting time domain locations, and wherein the condition is not satisfied based at least in part on the cast type of the sidelink communication being included in the one or more cast types.

20. The method of claim 18, wherein the condition indicates one or more cast types for which the UE is permitted to use the multiple available starting time domain locations, and wherein the condition is satisfied based at least in part on the cast type of the sidelink communication is included in the one or more cast types.

21. The method of claim 16, wherein the UE is communicating using a first radio access technology (RAT), wherein the one or more conditions include a condition associated with a channel busy ratio (CBR) that is associated with one or more RATs other than the first RAT, and wherein the condition is satisfied based at least in part on the channel busy ratio satisfying a CBR threshold.

22. The method of claim 21, further comprising measuring the CBR.

23. The method of claim 21, wherein the CBR threshold is a first threshold, wherein the condition is satisfied based at least in part the condition being satisfied for a quantity of UEs, including the UE, associated with a sidelink associated with the sidelink communication, that satisfies a second threshold.

24. The method of claim 23, wherein the UEs are transmitting UEs associated with the sidelink.

25. The method of claim 23, wherein the UEs are receiving UEs associated with the sidelink.

26. The method of claim 16, wherein the one or more conditions include a condition associated with an application that is associated with the sidelink communication, wherein the condition indicates one or more applications for which the UE is permitted to use the multiple available starting time domain locations, and wherein the condition is satisfied based at least in part on the application being included in the one or more applications.

27. The method of claim 16, wherein the starting time domain location is included in the one or more starting time domain locations that are not aligned with any slot boundary, wherein the one or more conditions include a condition associated with the energy detection threshold, wherein the condition indicates that the energy detection threshold is a modified energy detection threshold that is modified by an amount from another energy detection threshold associated with the channel access procedure, and wherein the condition is satisfied based at least in part on the one or more measurements satisfying the modified energy detection threshold.

28. The method of claim 27, wherein the condition associated with the energy detection threshold is applicable based at least in part on one or more other conditions, from the one or more conditions, being satisfied.

29. The method of claim 28, wherein the one or more other conditions include at least one of:
a first condition associated with a channel busy ratio of the sidelink channel,
a second condition associated with an average duty cycle associated with a sidelink that is associated with the sidelink communication, or
a third condition associated with a bandwidth occupancy of the sidelink.

30. The method of claim 16, wherein the one or more conditions include a condition associated with a reservation status of a slot in which the sidelink communication is to be transmitted, and wherein the condition is satisfied based at least in part on the reservation status indicating that no other UEs have reserved resources associated with the slot.
